(19) United States
(12) Patent Application Publication
(10) Pub. No.: US 2026/0343135 A1
(43) Pub. Date: Oct. 29, 2026

(54) OPEN-EAR HEADPHONES

(71) Applicant: SHENZHEN SHOKZ CO., LTD., Shenzhen (CN)

(72) Inventors: Lei ZHANG, Shenzhen (CN); Wenbing ZHOU, Shenzhen (CN); Burui GUO, Shenzhen (CN); Jinbo ZHENG, Shenzhen (CN); Chengqian ZHANG, Shenzhen (CN); Zhiqing LIU CHUN, Shenzhen (CN); Xin QI, Shenzhen (CN)

(73) Assignee: SHENZHEN SHOKZ CO., LTD., Shenzhen (CN)

(21) Appl. No.: 19/719,141

(22) Filed: Jun. 24, 2026

Related U.S. Application Data
(63) Continuation of application No. PCT/CN2025/109148, filed on Jul. 17, 2025.

(30) Foreign Application Priority Data
Jul. 17, 2024 (CN) 202410966001.5
Oct. 16, 2024 (CN) 202411452809.8
Dec. 15, 2024 (CN) 202411844133.7
May 16, 2025 (CN) 202520976939.5

(51) Int. Cl. H04R 1/10; H04R 9/02

(52) U.S. Cl. CPC H04R 1/1083; H04R 1/105; H04R 1/1091; H04R 9/025; H04R 2460/01; H04R 2460/09

(57) ABSTRACT

An open-ear headphone is provided, including a first housing and a sound generating assembly. The first housing has an inside wall and an outside wall. A loudspeaker includes a first diaphragm and a second diaphragm disposed opposite to each other in a vibration direction and vibrate synchronously in the same direction. The first diaphragm is spaced apart from the inside wall to form a first acoustic cavity. The second diaphragm is spaced apart from the outside wall to form a second acoustic cavity. The inside wall is provided with a first sound outlet acoustically communicated with the first acoustic cavity. The outside wall is provided with a second sound outlet acoustically communicated with the second acoustic cavity. The first sound outlet includes a plurality of first micro-holes arranged in an array. The second sound outlet includes a plurality of second micro-holes arranged in an array.

### CROSS-REFERENCE TO RELATED APPLICATIONS

This application is a continuation of International Application No. PCT/CN 2025/109148, filed on Jul. 17, 2025, which claims priority to Chinese Patent Application No. 202410966001.5, filed on Jul. 17, 2024, Chinese Patent Application No. 202411452809.8, filed on Oct. 16, 2024, Chinese Patent Application No. 202411844133.7, filed on Dec. 15, 2024, and Chinese Patent Application No. 202520976939.5, filed on May 16, 2025, the entire contents of each of which are hereby incorporated by reference.

### TECHNICAL FIELD

The present disclosure relates to the technical field of acoustics, and in particular to an open-ear headphone.

### BACKGROUND

Open-ear headphones have become an indispensable tool in people's daily life and work. With the continuous improvement of consumers” requirements for headphones, open-ear headphones need not only to have stable output performance, but also to be able to reduce ambient noise for normal listening in noisy or even high-noise environments. Therefore, noise cancellation performance has a great impact on the user experience of open-ear headphones. Thus, it is necessary to provide an open-ear headphone to improve the noise cancellation effect of the open-ear headphone.

### SUMMARY

The present disclosure provides an open-ear headphone, comprising a sound generating unit and an ear hook. The ear hook is configured to place the sound generating unit near an ear without blocking an ear canal in a wearing state. The sound generating unit includes a first housing and a sound generating assembly. The sound generating assembly is disposed inside the first housing. The first housing has an inside wall and an outside wall disposed opposite to each other. The inside wall faces the ear canal in the wearing state. The outside wall is farther from the ear canal than the inside wall in the wearing state. The sound generating assembly includes a loudspeaker. The loudspeaker includes a first diaphragm and a second diaphragm. The first diaphragm and the second diaphragm are disposed opposite to each other in a vibration direction and vibrate synchronously and in the same direction. The first diaphragm is closer to the inside wall than the second diaphragm. The first diaphragm and the inside wall are spaced apart and opposite to each other in the vibration direction to form a first acoustic cavity. The second diaphragm and the outside wall are spaced apart and opposite to each other in the vibration direction to form a second acoustic cavity. The inside wall is provided therethrough with a first sound outlet. The first sound outlet is acoustically connected to the loudspeaker through the first acoustic cavity. The outside wall is provided therethrough with a second sound outlet. The second sound outlet is acoustically connected to the loudspeaker through the second acoustic cavity. The first sound outlet includes a plurality of first micro-holes arranged in an array. The second sound outlet includes a plurality of second micro-holes arranged in an array. The open-ear headphone further comprises a microphone assembly, and the open-ear headphone is configured to adjust an output of the loudspeaker based on ambient noise collected by the microphone assembly to achieve active noise cancellation of the ambient noise.

In some embodiments, each of the first diaphragm and the second diaphragm includes a main region and a surround region surrounding the main region, the surround region of the first diaphragm and the surround region of the second diaphragm arch away from each other, the main region of the first diaphragm and the main region of the second diaphragm have a first interval distance along the vibration direction, an inner wall surface of the inside wall and an inner wall surface of the outside wall have a second interval distance that is a farthest distance along the vibration direction, a ratio of the first interval distance to the second interval distance is more than or equal to 70%, and the loudspeaker further includes a magnetic circuit assembly arranged between the first diaphragm and the second diaphragm.

In some embodiments, a total opening area of the plurality of second micro-holes is greater than a total opening area of the plurality of first micro-holes.

In some embodiments, a quantity of the plurality of second micro-holes is greater than a quantity of the plurality of first micro-holes.

In some embodiments, the open-ear headphone further comprises a first acoustic resistance mesh and a second acoustic resistance mesh, the first acoustic resistance mesh is disposed at the first sound outlet and inside the first acoustic cavity, the second acoustic resistance mesh is disposed at the second sound outlet and inside the second acoustic cavity, and a specific acoustic impedance of the first acoustic resistance mesh is less than a specific acoustic impedance of the second acoustic resistance mesh.

In some embodiments, at least a portion of a structure of the first housing extends into a concha cavity, the ear hook includes an adapter section connected to the sound generating unit, the microphone assembly includes a first microphone assembly, the first microphone assembly is disposed inside the adapter section, the adapter section is provided with a first sound pickup hole on a side close to the outside wall, and the first microphone assembly collects the ambient noise through the first sound pickup hole.

In some embodiments, at least a portion of a structure of the first housing extends into a concha cavity; the first housing further includes an upside wall, the upside wall faces a top of a head in the wearing state and connects the inside wall and the outside wall; the microphone assembly includes a second microphone assembly; the upside wall is provided with an opening; a portion of the second microphone assembly is accommodated inside the first housing via the opening, and another portion of the second microphone assembly protrudes outside the first housing; the open-ear headphone further comprises a protrusion disposed on the upside wall, wherein the portion of the second microphone assembly protruding outside the first housing is covered by the protrusion; the protrusion is provided with a second sound pickup hole on a side close to the outside wall; and the second microphone assembly collects the ambient noise through the second sound pickup hole.

In some embodiments, the open-ear headphone further comprises a limiting assembly, wherein the limiting assembly sealingly fixes the loudspeaker inside the first housing and sealingly forms the first acoustic cavity and the second acoustic cavity; the limiting assembly includes a first sealing ring and a second sealing ring; the first sealing ring elastically abuts against the inside wall; the second sealing ring elastically abuts against the outside wall; and the first sealing ring and the second sealing ring sealingly fix the loudspeaker from two sides in the vibration direction.

In some embodiments, the limiting assembly further includes a first cover and a second cover; the first cover includes a first transverse sidewall and a first longitudinal sidewall, the first transverse sidewall is disposed between the loudspeaker and the inside wall, and the first longitudinal sidewall surrounds and is fixedly connected to the loudspeaker around the vibration direction; the second cover includes a second transverse sidewall and a second longitudinal sidewall, the second transverse sidewall is disposed between the loudspeaker and the outside wall, and the second longitudinal sidewall surrounds and is fixedly connected to the loudspeaker around the vibration direction; one end of the first sealing ring in the vibration direction is fixed to the first transverse sidewall, and another end of the first sealing ring abuts against the inside wall; and one end of the second sealing ring in the vibration direction is fixed to the second transverse sidewall, and another end of the second sealing ring abuts against the outside wall.

In some embodiments, the first longitudinal sidewall and the second longitudinal sidewall are spaced apart along the vibration direction to form an accommodating gap surrounding the loudspeaker between the first cover and the second cover; the microphone assembly includes a second microphone assembly; at least a portion of the second microphone assembly is embedded in the accommodating gap; and the second microphone assembly is configured to collect ambient noise.

In some embodiments, the open-ear headphone further comprises a first acoustic resistance mesh and a second acoustic resistance mesh, the first transverse sidewall is provided with a first rib structure, the second transverse sidewall is provided with a second rib structure, the first rib structure is configured to support and fix the first acoustic resistance mesh inside the first acoustic cavity, the second rib structure is configured to support and fix the second acoustic resistance mesh inside the second acoustic cavity, and a quantity of the first rib structure and a quantity of the second rib structure are each between 3 and 5.

In some embodiments, each of the first diaphragm and the second diaphragm includes a main region and a surround region surrounding the main region; the surround region of the first diaphragm and the surround region of the second diaphragm arch away from each other; each of the first transverse sidewall and the second transverse sidewall has a central portion and an arc portion surrounding the central portion; in the vibration direction, the central portion of the first transverse sidewall faces the main region of the first diaphragm, and the arc portion of the first transverse sidewall faces the surround region of the first diaphragm; and the central portion of the second transverse sidewall faces the main region of the second diaphragm, and the arc portion of the second transverse sidewall faces the surround region of the second diaphragm.

In some embodiments, a first annular platform is provided at a connection between the arc portion of the first transverse sidewall and the first longitudinal sidewall; a second annular platform is provided at a connection between the arc portion of the second transverse sidewall and the second longitudinal sidewall; the first annular platform and the second annular platform abut against two sides of the loudspeaker, respectively, along the vibration direction; and a sealing adhesive is provided in an abutting region.

In some embodiments, the limiting assembly is provided with a first sound guiding hole communicating spaces on two sides of the first transverse sidewall and a second sound guiding hole communicating spaces on two sides of the second transverse sidewall; on a reference plane perpendicular to the vibration direction, a projection of the first sound guiding hole and a projection of the first diaphragm have a first overlapping region, an area ratio of the first overlapping region to the projection of the first sound guiding hole is more than or equal to 80%, a projection of the first sound outlet and the projection of the first sound guiding hole have a second overlapping region, an area ratio of the second overlapping region to the projection of the first sound outlet is more than or equal to 80%, a projection of the second sound guiding hole and a projection of the second diaphragm have a third overlapping region, an area ratio of the third overlapping region to the projection of the second sound guiding hole is more than or equal to 80%, and a projection of the second sound outlet and the projection of the second sound guiding hole have a fourth overlapping region, an area ratio of the fourth overlapping region to the projection of the second sound outlet is more than or equal to 80%.

In some embodiments, the loudspeaker further includes a magnetic circuit assembly and a voice coil assembly; the magnetic circuit assembly is disposed between the first diaphragm and the second diaphragm; the voice coil assembly includes a first voice coil and a second voice coil connected to each other and arranged in the vibration direction of the first diaphragm and the second diaphragm; the first voice coil and the second voice coil are respectively disposed through a magnetic gap of the magnetic circuit assembly; one end of the first voice coil away from the second voice coil is connected to the first diaphragm, and one end of the second voice coil away from the first voice coil is connected to the second diaphragm; and the magnetic circuit assembly cooperates with the voice coil assembly to drive the first diaphragm and the second diaphragm to vibrate synchronously and in the same direction.

In some embodiments, the first housing is an integral metal component; a thickness of the inside wall and a thickness of the outside wall are between 0.2 mm and 1 mm; an aperture diameter of each of the plurality of first micro-holes is more than or equal to 0.2 mm; an interval distance between adjacent first micro-holes is between 0.2 mm and 4 mm; an aperture diameter of each of the plurality of second micro-holes is more than or equal to 0.2 mm; and an interval distance between adjacent second micro-holes is between 0.2 mm and 4 mm.

In some embodiments, the ear hook includes an adapter section connected to the sound generating unit; the first housing is an integral metal component; the first housing is provided with a first opening at an end close to the adapter section; the sound generating assembly is inserted into the first housing through the first opening; and the adapter section is configured to be in a plug-in fit with the first housing via the first opening.

In some embodiments, the first housing further includes an upside wall and an end wall; the upside wall is disposed facing a top of a head in the wearing state and connects the inside wall and the outside wall; the end wall is located at an end of the first housing away from the adapter section and connects the inside wall, the outside wall, and the upside wall; wherein the open-ear headphone further comprises a protrusion disposed on at least one of the upside wall or the end wall; at least one of the upside wall or the end wall is provided with a second opening; a portion of the protrusion is embedded in the second opening, and another portion of the protrusion protrudes outside the first housing; a hardness of the protrusion is less than a hardness of the first housing; at least a portion of a structure of the first housing extends into a concha cavity; and the protrusion contacts a concha cavity wall.

In some embodiments, at least a portion of a structure of the first housing extends into a concha cavity; the first housing further includes an end wall, the end wall is located at an end of the first housing away from the ear hook and connects the inside wall and the outside wall; and the first sound outlet is disposed close to the end wall.

In some embodiments, the inside wall is provided therethrough with a sound tuning hole; the sound tuning hole is disposed at a position farther from the end wall than the first sound outlet; and an interval distance between the sound tuning hole and a nearest first micro-hole is more than or equal to 5 times an interval distance between adjacent first micro-holes.

A sound heard by a user is mainly a sound output from the first sound outlet. A frequency response curve of the first sound outlet has a first resonance peak and a second resonance peak, and a peak resonance frequency of the first resonance peak is less than that of the second resonance peak. A greater distance between the first resonance peak and the second resonance peak corresponds to a wider flat region of the frequency response curve of the sound output via the first sound outlet, enabling the open-ear headphone to support active noise cancellation in a wider frequency band.

A first Helmholtz resonance cavity model may be formed based on a connection relationship between the first acoustic cavity and the first sound outlet, and a second Helmholtz resonance cavity model may be formed based on a connection relationship between the second acoustic cavity and the second sound outlet, the first sound outlet and the second sound outlet serving as necks of the corresponding Helmholtz resonance cavity models. The second resonance peak is generated by the first Helmholtz resonance cavity model, and the peak resonance frequency of the second resonance peak is approximately equal to a resonance frequency of the first Helmholtz resonance cavity model. It should be noted that, in addition to being output via the second sound outlet, vibration generated by the second Helmholtz resonance cavity model is further superimposed on the sound output from the first sound outlet along with the synchronous vibration of the first diaphragm and the second diaphragm, causing the frequency response curve output from the first sound outlet to generate an extra resonance peak in addition to the first resonance peak and the second resonance peak, which can be referred to as a third resonance peak. If the third resonance peak is located before the second resonance peak, it will affect the frequency band width of active noise cancellation.

The resonance frequency of the Helmholtz resonance cavity model is mainly affected by a cross-sectional area of the neck and a volume of the cavity. The larger the cross-sectional area of the neck, the higher the resonance frequency; the smaller the cavity volume, the higher the resonance frequency. For the first Helmholtz resonance cavity model, the larger the total opening area of the first sound outlet and the smaller the volume of the first acoustic cavity, the higher the resonance frequency thereof. For the second Helmholtz resonance cavity model, the larger the total opening area of the second sound outlet and the smaller the volume of the second acoustic cavity, the higher the resonance frequency thereof.

In the solution of the present disclosure, by providing the loudspeaker including dual diaphragms spaced apart in the vibration direction, it is beneficial to reduce the distance between the first diaphragm and the inside wall and the distance between the second diaphragm and the outside wall, thereby facilitating the reduction of volumes of the first acoustic cavity and the second acoustic cavity. Furthermore, by providing the first sound outlet as the plurality of first micro-holes arranged in an array and the second sound outlet as the plurality of second micro-holes arranged in an array, the first sound outlet and the second sound outlet each have a relatively large total opening area while avoiding an excessively large single opening area, which can allow foreign matter to enter easily and affect the appearance of the open-ear headphone.

The solution of the present disclosure can reduce the volume of the first acoustic cavity, enable the first sound outlet to have a relatively large total opening area, and increase the resonance frequency of the first Helmholtz resonance cavity model, thereby shifting the second resonance peak towards higher frequencies and thus increasing the frequency band width of active noise cancellation. On the other hand, the solution of the present disclosure can also reduce the volume of the second acoustic cavity, enable the second sound outlet to have a relatively large total opening area, increase the resonance frequency of the second Helmholtz resonance cavity model, and shift the third resonance peak towards higher frequencies, thereby reducing an impact of the vibration generated by the second Helmholtz resonance cavity model on the frequency band width of active noise cancellation.

In addition, in the solution of the present disclosure, by providing the dual diaphragms vibrating synchronously and in the same direction, it is not only beneficial to counteract nonlinearity of a single diaphragm, reduce distortion in a low frequency band, and reduce phase fluctuation, but also beneficial to increase the sound volume in the low frequency band, thereby improving an active noise cancellation effect in the low frequency band.

### BRIEF DESCRIPTION OF THE DRAWINGS

FIG. 1 is a schematic diagram illustrating an outline of an anterior aspect of an ear according to the present disclosure;

FIG. 2 is a schematic diagram illustrating a wearing state of a headphone according to some embodiments when worn on an ear;

FIG. 3 is a schematic diagram illustrating an outer contour structure of a headphone according to some embodiments;

FIG. 4 is a schematic diagram illustrating a cross-sectional structure of a sound generating unit in a long axis direction according to some embodiments;

FIG. 5 is a schematic diagram illustrating a cross-sectional structure of a sound generating unit in a short axis direction according to some embodiments;

FIG. 6 is a schematic diagram illustrating a structural decomposition of a sound generating unit according to some embodiments;

FIG. 7 is a schematic diagram illustrating a structure of a headphone according to some embodiments;

FIG. 8 is a schematic diagram illustrating a decomposition of a headphone according to some embodiments;

FIG. 9 is a schematic diagram illustrating a decomposition of a partial structure of a headphone according to some embodiments;

FIGS. 10A and 10B are schematic diagrams illustrating different quantities of sound outlets according to some embodiments;

FIG. 11 is a schematic diagram illustrating frequency response curves corresponding to different shapes and quantities of sound outlets according to some embodiments;

FIGS. 12A to 12F are schematic diagrams illustrating different distribution forms of sound outlets according to some embodiments;

FIG. 13 is a schematic diagram illustrating frequency response curves corresponding to the sound outlets in FIGS. 12A to 12F according to some embodiments;

FIG. 14 is a schematic diagram illustrating a relative distance between a first sound outlet and a sound tuning hole according to some embodiments;

FIG. 15 is a schematic diagram illustrating frequency response curves corresponding to different L1-X or L2-X in FIG. 14 according to some embodiments;

FIG. 16 is a schematic diagram illustrating frequency response curves corresponding to different area ratios between the first sound outlet and the sound tuning hole in FIG. 14 according to some embodiments;

FIG. 17 is a schematic diagram illustrating a relative position between a first sound outlet and a sound tuning hole according to some embodiments;

FIG. 18 is a schematic diagram illustrating a structure of a sound generating assembly in a sound generating unit according to some embodiments;

FIG. 19 is a schematic diagram illustrating a structural decomposition of a sound generating assembly according to some embodiments;

FIG. 20 is a schematic diagram illustrating a cross-sectional structure of a sound generating assembly according to some embodiments;

FIG. 21 is a schematic diagram illustrating a cross-sectional structure of a loudspeaker according to some embodiments;

FIG. 22 is a schematic diagram illustrating a structure of a voice coil assembly according to some embodiments; and

FIG. 23 is a schematic diagram illustrating a structural decomposition of the voice coil assembly in FIG. 22 according to some embodiments.

### DETAILED DESCRIPTION

Hereinafter, the present disclosure will be further described in detail with reference to specific embodiments and the accompanying drawings. Similar elements in different embodiments are denoted by associated similar reference numerals. In the following embodiments, many details are for a better understanding of the present disclosure. However, those skilled in the art can easily recognize that some of the features may be omitted in different situations, or may be replaced by other elements, materials, or manners. In some cases, some operations related to the present disclosure are not shown or described in the present disclosure. This is to avoid the core part of the present disclosure being overwhelmed by excessive descriptions. For those skilled in the art, detailed descriptions of these related operations are not necessary, as they can fully understand the related operations based on the descriptions in the present disclosure and general technical knowledge in the art.

In addition, the features, operations, or characteristics described in the present disclosure may be combined in any suitable manner to form various embodiments. Meanwhile, the steps or actions in the description of the manners may also be reordered or adjusted in a manner obvious to those skilled in the art. Therefore, the various sequences in the present disclosure and the accompanying drawings are merely for clearly describing an embodiment, and do not imply a mandatory sequence, unless otherwise specified that a certain sequence must be followed.

The numbering of components herein (e.g., “first”, “second”, or the like) is merely for distinguishing the described objects and does not have any sequential or technical meaning. As used herein, “connection” and “coupling”, unless otherwise specified, both include direct and indirect connections (couplings).

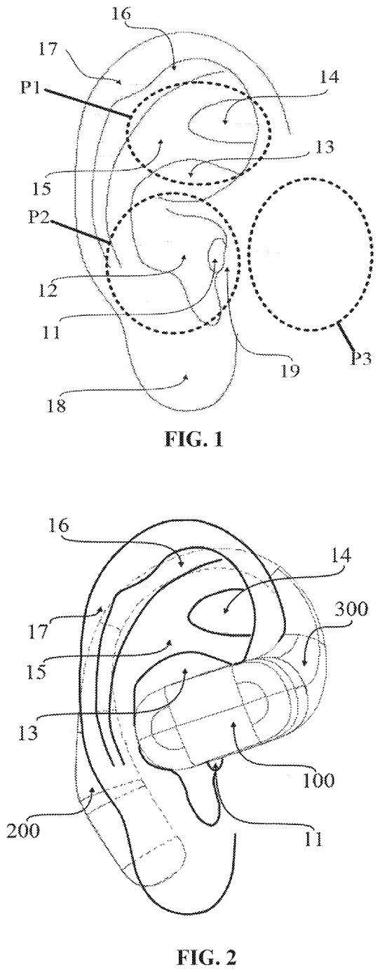

FIG. 1 is a schematic diagram illustrating a physiological structure of an exemplary ear according to some embodiments of the present disclosure. Referring to FIG. 1, the exemplary ear may include physiological parts such as an ear canal 11, a concha cavity 12, a cymba conchae 13, a triangular fossa 14, an antihelix 15, a scapha 16, a helix 17, an earlobe 18, a crus of helix 19, or the like. Although the ear canal 11 has a certain depth and extends to an eardrum of the ear, the ear canal 11 may be understood as its entrance away from the eardrum (i.e., an ear hole or an ear canal opening) unless otherwise specified. Further, the physiological parts such as the concha cavity 12, the cymba conchae 13, the triangular fossa 14, or the like, have a certain volume and depth in a three-dimensional space. The concha cavity 12 is directly connected to the ear canal 11, which may be simply regarded as the aforementioned ear hole being located at a bottom of the concha cavity 12.

Since the physiological parts such as the ear canal 11, the concha cavity 12, the cymba conchae 13, the triangular fossa 14, or the like, have a certain depth and volume in the three-dimensional space, for a headphone provided according to some embodiments of the present disclosure, stable wearing of the headphone may be achieved by means of one or more physiological parts of the ear.

By way of example, wearing of the headphone is achieved by means of other parts of the ear except the ear canal 11 (e.g., the cymba conchae 13, the triangular fossa 14, the antihelix 15, the scapha 16, the helix 17, or the like, or a combination thereof). For example, in a wearing state, a whole or a portion of a structure of the headphone may contact an upper part of the ear canal 11 (e.g., one or more physiological parts such as the cymba conchae 13, the triangular fossa 14, the antihelix 15, the scapha 16, the helix 17, the crus of helix 19, or the like). As another example, in the wearing state, the whole or a portion of the structure of the headphone may be located in a first region P1 delimited by dashed lines in FIG. 1, which at least includes the cymba conchae 13 and the triangular fossa 14, or may be located in a second region P2 delimited by dashed lines in FIG. 1, which at least includes the concha cavity 12, or may be located in a front side of the crus of helix 19 (i.e., in a third region P3 delimited by dashed lines in FIG. 1).

By means of other parts of the ear except the ear canal 11, wearing of the headphone and transmission of sound are achieved, which not only can “liberate the ear canal” and reduce the influence of the headphone on the ear health of the user, but also can effectively improve the user experience of the headphone. For example, when the user wears the headphone on a road, the headphone does not block the ear canal 11, thereby allowing the user to receive sound from the headphone and also receive ambient sound (e.g., a horn sound, a bicycle bell sound, surrounding human voices, traffic command sounds, or the like), thereby being capable of effectively reducing an occurrence of traffic accidents.

Since different users may have individual differences, which cause the ear to have dimensional differences such as different shapes, sizes, or the like. To facilitate description and understanding and to reduce or even eliminate individual differences among different users, unless otherwise specified, the present disclosure mainly takes an ear model having a “standard” shape and size as a reference, to describe the structure of the headphone in different embodiments and a wearing method thereof on the ear model. For example, a simulator (e.g., GRAS 45BC KEMAR) including a head and its (left and right) ears may be prepared based on ANSI: S3.36, S3.25 and IEC: 60318-7 standards, as a reference object for wearing a headphone, thereby presenting a scenario where most users wear a headphone normally.

Therefore, descriptions such as “user wearing”, “in a wearing state”, “in the wearing state”, or the like, in the present disclosure may refer to the headphone described in the present disclosure being worn on the ear of the aforementioned simulator. Of course, considering that different users have individual differences, the structure, shape, size, thickness, or the like, of one or more parts of the ear may be differently designed according to ears of different shapes and sizes. These differentiated designs may be reflected as characteristic parameters of one or more parts in the headphone having different ranges of values to adapt to different ears.

It should be noted that in fields such as medicine, anatomy, or the like, three basic cutting planes, namely a sagittal plane, a coronal plane, and a horizontal plane, and three basic axes, namely a sagittal axis, a coronal axis, and a vertical axis, of the human body may be defined.

The sagittal plane refers to a cutting plane made along a front-back direction of the human body and perpendicular to the ground, dividing the human body into left and right parts. The coronal plane refers to a cutting plane made along a left-right direction of the human body and perpendicular to the ground, dividing the human body into front and rear parts. The horizontal plane refers to a cutting plane oriented along an up-down direction of the human body and parallel to the ground, dividing the human body into upper and lower parts. Correspondingly, the sagittal axis refers to an axis along the front-back direction of the human body and perpendicular to the coronal plane; the coronal axis refers to an axis along the left-right direction of the human body and perpendicular to the sagittal plane; and the vertical axis refers to an axis along the up-down direction of the human body and perpendicular to the horizontal plane.

Further, “a front side of the ear” described in the present disclosure is a concept relative to “a rear side of the ear”, where the former refers to a side of the ear away from a head, and the latter refers to a side of the ear facing the head, and both are directed to the ear of the user. When observing the ear of the aforementioned simulator along a direction of the coronal axis of the human body, a schematic diagram of a front side profile of the ear shown in FIG. 1 may be obtained.

It should be noted that, the foregoing descriptions regarding the ear are merely for illustrative purposes, and are not intended to limit the scope of the present disclosure. For those skilled in the art, various changes and modifications may be made according to the descriptions of the present disclosure (e.g., a portion of a structure of the headphone may shield a portion or a whole of the ear canal 11), and these changes and modifications still fall within the protection scope of the present disclosure.

For an open-ear headphone (hereinafter referred to as the headphone), in the wearing state, a sound generating unit of the headphone generally cannot form a relatively enclosed sound transmission channel with the ear canal 11, which may cause ambient noise to enter the ear canal 11 and generate a significant influence on the listening experience of the user.

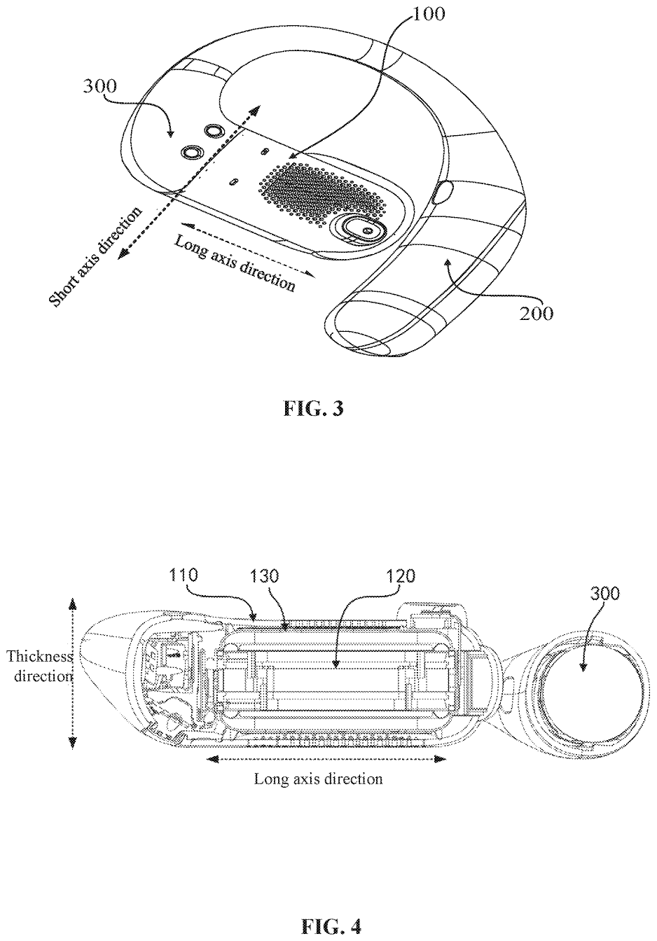

In order to be capable of weakening or offsetting ambient noise in a noisy or even high-noise environment, thereby achieving an active noise cancellation function of the headphone and improving the listening effect of the headphone, referring to FIG. 2 and FIG. 3, an open-ear headphone (headphone) is provided in some embodiments of the present disclosure. The headphone includes a sound generating unit 100 and an ear hook. The ear hook is configured to place the sound generating unit 100 near the ear without blocking the ear canal 11 in the wearing state. It should be noted that, due to individual differences among different users, when the headphone is worn by different users, the sound generating unit 100 may partially block the ear canal 11, but the ear canal 11 is still not sealed. Further details are provided below.

Referring to FIG. 4 to FIG. 6, the sound generating unit 100 includes a first housing 110 and a sound generating assembly. The sound generating assembly is disposed inside the first housing 110, and the sound generating assembly includes a loudspeaker 120. The loudspeaker 120 can convert an electrical signal into a corresponding mechanical vibration, thereby generating a sound output (e.g., a noise cancellation sound or an audio played by the headphone). A sound generated by the loudspeaker 120 may include a noise cancellation sound. The noise cancellation sound output to an outside of the first housing 110 may be the same as an amplitude of ambient noise near the ear canal 11 and opposite in phase, to eliminate the ambient noise near the ear canal 11 and achieve active noise cancellation. The sound generated by the loudspeaker 120 may also include other sounds such as a call sound, a played audio, a reminder sound, or the like. After these sounds are output to the outside of the first housing 110, they may be guided to the ear canal 11 to ensure a listening effect for the user.

In some embodiments, the sound generating assembly may further include a limiting assembly 130, wherein the limiting assembly 130 is configured to position and limit the loudspeaker 120 inside the first housing 110. On one hand, by positioning the loudspeaker 120 inside the first housing 110, a sound generated by the loudspeaker 120 can be stably output to the outside of the first housing 110 through an acoustic hole disposed in the first housing 110. On the other hand, by limiting the loudspeaker 120, the loudspeaker 120 can be prevented from shaking relative to the first housing 110 during vibration, thereby ensuring a sound output performance of the sound generating unit 100.

As shown in FIG. 6, in some embodiments, the first housing 110 is a metal component, thereby allowing the sound generating unit 100 to present a metallic texture in appearance. Merely by way of example, the first housing 110 may be an integral metal component. The first housing 110 is provided with a first opening 1101 at an end close to an adapter section 300. The sound generating assembly is inserted into the first housing 110 through the first opening 1101, thereby achieving assembly in a relatively simple manner.

In some embodiments, the headphone further includes a microphone assembly configured to collect a sound signal (e.g., a user speech, an ambient sound, or the like). The headphone is further configured to adjust an output of the loudspeaker 120 based on the ambient noise collected by the microphone assembly, so that the sound output by the loudspeaker 120 includes a sound signal that cancels out the ambient noise, thereby achieving active noise cancellation of the ambient noise by the headphone.

In some embodiments, referring to FIG. 2 and FIG. 3, the ear hook may include an ear hook housing and a battery assembly, a circuit board assembly, or the like, disposed inside the ear hook housing. Structures such as the battery assembly, the loudspeaker 120, and the microphone assembly are electrically connected to the circuit board assembly. The circuit board assembly may be understood as a collection of a main control board or a main board of the headphone and related components. The circuit board assembly plays a regulatory and management role for all or a portion of functional components in the headphone. For example, the circuit board assembly is configured to perform conversion processing on electrical signals in the headphone to support the realization of various functions of the headphone (e.g., supporting the headphone to realize power on/off, playback content switching, volume increase/decrease, or the like).

By way of example, referring to FIG. 3, the ear hook may be divided into two parts, namely a battery section 200 and the adapter section 300, along a length direction of the ear hook. The adapter section 300 is connected between the battery section 200 and the sound generating unit 100. In the wearing state, a portion of the battery section 200 (e.g., a portion occupied by the battery assembly and the circuit board assembly) hangs between an auricle and a head. Another portion of the battery section 200 extends to a side of the auricle away from the head and is connected to the adapter section 300, thereby wearing the sound generating unit 100 near the ear canal 11 but without blocking the ear canal 11, such that the headphone functions as an open-ear headphone. In some embodiments, the battery assembly, the circuit board assembly, or the like, may be disposed in the battery section 200, and the adapter section 300 may be provided with headphone buttons and components such as an adapter board configured to electrically connect the circuit board assembly to the loudspeaker 120, the microphone assembly, or the like. Referring also to FIG. 3 and FIG. 6, the adapter section 300 may be configured to be in a plug-in fit with the first housing 110 via the first opening 1101.

In some embodiments, to improve a stability of the headphone in the wearing state, the headphone may adopt any one or a combination of the following manners. Firstly, at least a portion of the ear hook is configured as a contoured structure (e.g., an arc-shaped barb-like structure) that fits at least one of the rear side of the ear or the head, to increase a contact area between the ear hook and the ear or the head, thereby increasing a resistance of the headphone from falling off the ear. Secondly, at least a portion of the ear hook is configured as an elastic structure, thereby allowing the ear hook to have a certain elastic deformation amount in the wearing state, to increase a pressure of the ear hook on the ear or the head, thereby increasing the resistance of the headphone from falling off the ear. Thirdly, at least a portion of the ear hook is configured to abut against the head in the wearing state, thereby allowing the ear hook to form a reaction force pressing against the ear, such that the sound generating unit 100 is pressed against the front side of the ear, thereby increasing the resistance of the headphone from falling off the ear. Fourthly, the sound generating unit 100 and the ear hook are configured to clamp physiological parts such as a region where the helix 17 is located, a region where the concha cavity 12 is located, or the like, respectively, from the front and rear sides of the ear in the wearing state, thereby increasing the resistance of the headphone from falling off the ear. Fifthly, the sound generating unit 100 is configured to at least partially extend into physiological parts such as the concha cavity 12, the cymba conchae 13, the triangular fossa 14, the scapha 16, or the like, in the wearing state, thereby increasing the resistance of the headphone from falling off the ear.

In some embodiments, the headphone may be combined with products such as glasses, head-mounted headphones, head-mounted display devices, Augmented Reality/Virtual Reality (AR/VR) helmets, or the like, and the sound generating unit 100 is worn near the ear of a user in manners such as hanging, clamping, or the like.

In view of that, some existing headphones configured to achieve active noise cancellation mostly only support active noise cancellation within a relatively narrow frequency band range. To enable the headphone to have a flatter output within a relatively wide frequency band range, thereby effectively enhancing the active noise cancellation effect of the headphone in open-ear application scenarios, the sound generating unit 100 is mainly introduced below.

Referring to FIGS. 3 to 6, the sound generating unit 100 may have a long axis direction and a short axis direction that are perpendicular to a thickness direction and mutually orthogonal. The long axis direction may be defined as a direction having a maximum extension dimension in a shape of a two-dimensional projection plane of the sound generating unit 100 (e.g., a projection of the sound generating unit 100 on a plane where an outside wall thereof is located, or a projection of the sound generating unit 100 on a sagittal plane). The short axis direction may be defined as a direction perpendicular to the long axis direction in a shape of the projection of the sound generating unit 100 on the sagittal plane. For example, when the shape of the projection is rectangular or approximately rectangular, the long axis direction refers to a length direction of the rectangular or approximately rectangular shape, and the short axis direction refers to a width direction of the rectangular or approximately rectangular shape. The thickness direction refers to a direction perpendicular to the two-dimensional projection plane. For example, the thickness direction may be consistent with a direction of the coronal axis, both pointing to the left-right direction of the body. In some embodiments, the thickness direction may also be defined as a direction of the housing approaching or moving away from the ear in the wearing state. In some embodiments, when the sound generating unit 100 is in a tilted state in the wearing state, the long axis direction and the short axis direction may still be parallel or approximately parallel to the sagittal plane. The long axis direction may have a certain angle with a direction of the sagittal axis, meaning that the long axis direction is also set obliquely accordingly. The short axis direction may have a certain angle with a direction of the vertical axis, meaning that the short axis direction is also set obliquely. In some embodiments, at least a portion of a structure of the housing of the sound generating unit 100 may extend into the concha cavity 12. That is to say, a projection of the housing of the sound generating unit 100 on the sagittal plane and a projection of the concha cavity 12 on the sagittal plane have an overlapping region. It should be noted that in the present disclosure, when “projection” is mentioned, it uniformly refers to an orthogonal projection.

Referring to FIG. 6, the first housing 110 of the sound generating unit 100 includes an inside wall 110a and an outside wall 110b disposed opposite to each other. The inside wall 110a is a housing sidewall of the first housing 110 on a side facing the ear (e.g., the ear canal 11) in the thickness direction in the wearing state. The outside wall 110b is a housing sidewall of the first housing 110 on a side moving away from the ear (e.g., the ear canal 11) in the thickness direction in the wearing state.

The first housing 110 of the sound generating unit 100 may further include an upside wall 110c, a downside wall 110d, and an end wall 110e. The upside wall 110c is a housing sidewall of the first housing 110 on a side closer to a top of the head in the short axis direction in the wearing state. The downside wall 110d is a housing sidewall of the first housing 110 on a side farther from the top of the head in the short axis direction in the wearing state. The end wall 110e refers to a housing sidewall at an end of the first housing 110 away from the adapter section 300. Each of the upside wall 110c, the downside wall 110d, and the end wall 110e connects the inside wall 110a and the outside wall 110b. It may be understood that the plurality of different housing walls may cooperatively enclose an accommodating cavity of the sound generating unit 100, and the sound generating assembly (e.g., the loudspeaker 120, or the like) is accommodated and disposed within the accommodating cavity.

Referring to FIGS. 6 to 9, in some embodiments, the headphone further includes a protrusion 400 disposed on the upside wall 110c and the end wall 110e, respectively. The upside wall 110c and the end wall 110e are each provided with a second opening 1102. A portion of the protrusion 400 is embedded in the second opening 1102, and another portion of the protrusion 400 protrudes outside the first housing 110. A hardness of the protrusion 400 is less than a hardness of the first housing 110. At least a portion of a structure of the first housing 110 extends into the concha cavity, and the protrusion 400 contacts a concha cavity wall. By providing the protrusion 400 with a relatively small hardness to contact the concha cavity wall, it is beneficial to improve wearing comfort. For example, the outermost layer of the protrusion 400 may employ a silicone material.

In some embodiments, the protrusion 400 may also be disposed only on the upside wall 110c, or only on the end wall 110e. As mentioned in the present disclosure, the “protrusion 400 disposed on the upside wall 110c and/or the end wall 110e” refers to the fact that the protrusion 400 may be disposed on at least one of the upside wall 110c or the end wall 110e. Furthermore, the “A and/or B” mentioned in the present disclosure should all be understood as at least one of A or B.

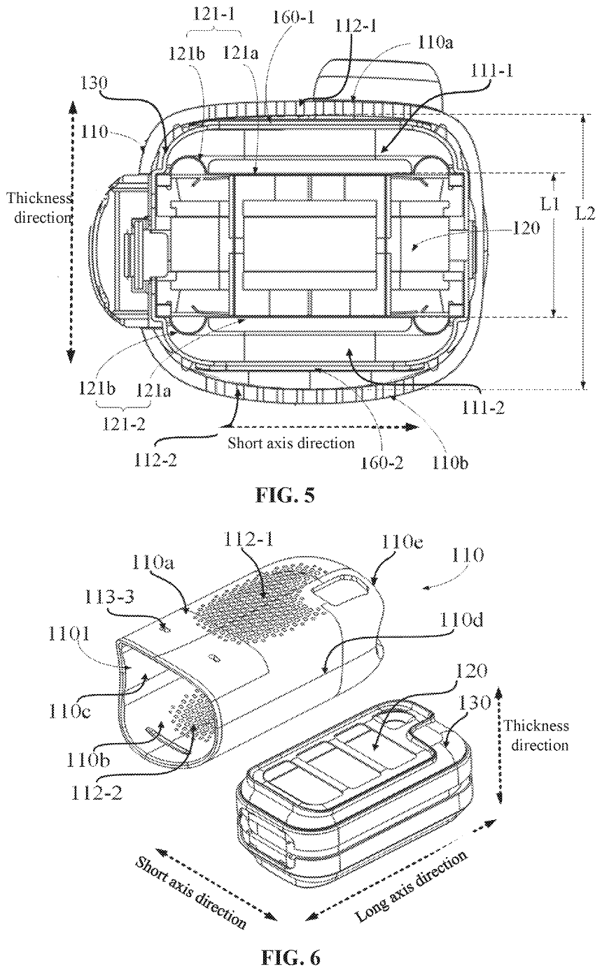

Referring to FIG. 5, inside the first housing 110, a first acoustic cavity 111-1 is formed between the loudspeaker 120 and the inside wall 110a, and a second acoustic cavity 111-2 is formed between the loudspeaker 120 and the outside wall 110b. Correspondingly, the inside wall 110a is provided therethrough with a first sound outlet 112-1 acoustically connected to the loudspeaker 120 through the first acoustic cavity 111-1, and the outside wall 110b is provided therethrough with a second sound outlet 112-2 acoustically connected to the loudspeaker 120 through the second acoustic cavity 111-2.

The loudspeaker 120 employs a dual-diaphragm loudspeaker, which includes a first diaphragm 121-1 and a second diaphragm 121-2 disposed opposite to each other in a vibration direction. The first diaphragm 121-1 and the second diaphragm 121-2 vibrate synchronously and in the same direction. The “same direction” refers to the fact that the vibration direction of the first diaphragm 121-1 and the vibration direction of the second diaphragm 121-2 are consistent. The “synchronously” refers to the fact that vibration states of the first diaphragm 121-1 and the second diaphragm 121-2 are consistent in time. That is to say, vibration phases of the first diaphragm 121-1 and the second diaphragm 121-2 are consistent. The first diaphragm 121-1 is closer to the inside wall 110a than the second diaphragm 121-2. The first diaphragm 121-1 and the inside wall 110a are spaced apart and opposite to each other in the vibration direction (i.e., the thickness direction) to form the first acoustic cavity 111-1. The second diaphragm 121-2 and the outside wall 110b are spaced apart and opposite to each other in the vibration direction to form the second acoustic cavity 111-2.

Affected by various factors such as manufacturing, or the like, it is difficult for the vibration phases of the first diaphragm 121-1 and the second diaphragm 121-2 to be completely consistent under ideal conditions. Therefore, the “vibration phase consistency” described in the present disclosure may refer to that at least within a sound frequency band between a first resonance peak and a second resonance peak (more descriptions regarding the first resonance peak and the second resonance peak may be found in the following related descriptions), a phase difference between the first diaphragm 121-1 and the second diaphragm 121-2 at different frequencies is always less than 35°. For example, test conditions for the phase difference between the first diaphragm 121-1 and the second diaphragm 121-2 may be set based on IEC 60268-7. For example, a ½ inch standard microphone may be placed in a free field near the first sound outlet 112-1, and another ½ inch standard microphone may be placed near the second sound outlet 112-2, to determine the phase difference between the first diaphragm 121-1 and the second diaphragm 121-2 based on sound signals collected by the two standard microphones.

As shown in FIGS. 3 to 6, the first sound outlet 112-1 includes a plurality of first micro-holes arranged in an array, and the second sound outlet 112-2 includes a plurality of second micro-holes arranged in an array.

The sound heard by the user is mainly a sound output from the first sound outlet 112-1. A frequency response curve output from the first sound outlet 112-1 has a first resonance peak and a second resonance peak. A peak resonance frequency of the first resonance peak is less than a peak resonance frequency of the second resonance peak. The first resonance peak may be generated by a hardware structure in the sound generating unit 100, and the peak resonance frequency of the first resonance peak is mainly affected by acoustic components in the loudspeaker 120, e.g., the diaphragm(s), a magnetic circuit assembly, and a voice coil assembly. In some embodiments, with a gradual increase in frequency, the frequency response curve output from the first sound outlet 112-1 may have a plurality of rising segments, wherein the first resonance peak may refer to a first one of the rising segments. For example, the peak resonance frequency of the first resonance peak may be set to be no more than 300 Hz.

By utilizing a communication relationship between the first acoustic cavity 111-1 and the first sound outlet 112-1, a first Helmholtz resonator model may be formed. By utilizing a communication relationship between the second acoustic cavity 111-2 and the second sound outlet 112-2, a second Helmholtz resonator model may be formed. The first sound outlet 112-1 and the second sound outlet 112-2 serve as respective necks of the corresponding Helmholtz resonator models. The second resonance peak may be generated by the first Helmholtz resonator model, and the peak resonance frequency of the second resonance peak is approximately equal to a resonance frequency of the first Helmholtz resonator model.

Between the first resonance peak and the second resonance peak, a flat region with a relatively stable sound pressure level may be formed, and a peak sound pressure level of the second resonance peak is higher than a sound pressure level of the flat region. In some embodiments, the peak sound pressure level of the second resonance peak may be higher than the sound pressure level of the flat region by more than 2 dB. Test conditions may be set based on IEC 60268-7, for example, a ½ inch standard microphone may be used in a free field, and measurements may be performed under conditions where the microphone is 2 mm away from the sound outlet(s) of the headphone. For example, the peak resonance frequency of the second resonance peak may be set to be no less than 3.65 kHz, for example, no less than 4.5 kHz, no less than 5.8 kHz, no less than 6.7 kHz, no less than 7.5 kHz, no less than 7.75 kHz, no less than 8.75 kHz, no less than 9.25 kHz, no less than 9.5 kHz, or the like.

The farther the distance between the first resonance peak and the second resonance peak, the wider the width of the flat region of the frequency response curve of sound output from the first sound outlet 112-1, thereby enabling the headphone to achieve active noise cancellation within a wider frequency band range.

It should be noted that in addition to being output via the second sound outlet 112-2, vibrations generated by the second Helmholtz resonator model may also be superimposed onto the sound output from the first sound outlet 112-1 along with synchronous vibrations of the first diaphragm and the second diaphragm, thereby causing the frequency response curve output from the first sound outlet 112-1 to generate an additional resonance peak other than the first resonance peak and the second resonance peak, which may be referred to as a third resonance peak. If the third resonance peak is located before the second resonance peak, it may affect the frequency band width of active noise cancellation.

A resonance frequency of a Helmholtz resonator model is mainly affected by a cross-sectional area of a neck and a volume of a cavity, wherein the larger the cross-sectional area of the neck, the larger the resonance frequency, and the smaller the volume of the cavity, the larger the resonance frequency. For the first Helmholtz resonator model, the larger the total opening area of the first sound outlet 112-1, the smaller the volume of the first acoustic cavity 111-1, and the larger its resonance frequency. For the second Helmholtz resonator model, the larger the total opening area of the second sound outlet 112-2, the smaller the volume of the second acoustic cavity 111-2, and the larger its resonance frequency.

In the solution of the present disclosure, by providing that the loudspeaker 120 includes dual diaphragms, and the dual diaphragms are spaced apart in the vibration direction, it is beneficial to reduce a distance between the first diaphragm 121-1 and the inside wall 110a and a distance between the second diaphragm 121-2 and the outside wall 110b, thereby facilitating a reduction in volumes of the first acoustic cavity 111-1 and the second acoustic cavity 111-2. Furthermore, by providing that the first sound outlet 112-1 includes a plurality of first micro-holes arranged in an array, and the second sound outlet 112-2 includes a plurality of second micro-holes arranged in an array, thereby causing the first sound outlet 112-1 and the second sound outlet 112-2 to respectively have the relatively large total opening area, while also avoiding an excessively large single opening area, as an excessively large single opening area may allow foreign objects to easily enter and may also affect an appearance of the headphone.

The solution of the present disclosure can reduce the volume of the first acoustic cavity 111-1 and causes the first sound outlet 112-1 to have the relatively large total opening area, thereby increasing the resonance frequency of the first Helmholtz resonator model, which in turn causes the second resonance peak to shift towards a high frequency, thereby increasing the frequency band width of active noise cancellation. On the other hand, the solution of the present disclosure can also reduce the volume of the second acoustic cavity 111-2 and causes the second sound outlet 112-2 to have the relatively large total opening area, thereby increasing the resonance frequency of the second Helmholtz resonator model, causing the third resonance peak to shift towards a high frequency, and reducing an influence of vibrations generated by the second Helmholtz resonator model on the frequency band width of active noise cancellation.

Furthermore, in the solution of the present disclosure, by providing that the dual diaphragms vibrate synchronously and in the same direction, it is not only beneficial to cancel non-linearity of a single diaphragm, reduce distortion in a low frequency band, and reduce phase fluctuations, but also beneficial to increase a volume in the low frequency band, thereby facilitating an improvement in the active noise cancellation effect in the low frequency band.

By way of example, in some embodiments, a ratio of the peak resonance frequency of the second resonance peak to the peak resonance frequency of the first resonance peak may be set to be no less than 3, thereby effectively increasing the width of the flat region of the frequency response curve of sound output from the first sound outlet 112-1, and providing support for the headphone to achieve active noise cancellation within a wider frequency band range. In some embodiments, the ratio of the peak resonance frequency of the second resonance peak to the peak resonance frequency of the first resonance peak may be set to be no less than 13. In some embodiments, the ratio of the peak resonance frequency of the second resonance peak to the peak resonance frequency of the first resonance peak may be set to be no less than 20.

In some embodiments, in the wearing state, at least a portion of the first housing 110 may be located within the concha cavity 12. The inside wall 110a cooperates with the concha cavity 12 to form an auxiliary cavity communicating with the ear canal 11. The auxiliary cavity is usually in a semi-open state, and the first sound outlet 112-1 is located within the auxiliary cavity. In this manner, the sound output from the first sound outlet 112-1 may be restricted and gathered by the auxiliary cavity. A majority of the sound may propagate into the ear canal 11, while a small portion of the sound propagating outside the ear canal 11 (e.g., the noise cancellation sound) may be anti-phase cancelled with the ambient noise near the ear canal 11, thereby being beneficial for both improving a listening effect and enhancing the active noise cancellation effect, and also beneficial for reducing a sound leakage problem.

As shown in FIG. 5, in some embodiments, each of the first diaphragm 121-1 and the second diaphragm 121-2 includes a main region 121a and a surround region 121b surrounding the main region 121a. The surround region 121b of the first diaphragm 121-1 and the surround region 121b of the second diaphragm 121-2 arch away from each other. Such a configuration is beneficial for further reducing the volumes of the first acoustic cavity 111-1 and the second acoustic cavity 111-2, increasing the resonance frequency of the first Helmholtz resonator model, which in turn causes the second resonance peak to shift towards a high frequency, thereby increasing the frequency band width of active noise cancellation, and increasing the resonance frequency of the second Helmholtz resonator model, causing the third resonance peak to shift towards a high frequency, and reducing the influence of vibrations generated by the second Helmholtz resonator model on the frequency band width of active noise cancellation.

The loudspeaker 120 may further include a magnetic circuit assembly and a voice coil assembly disposed between the first diaphragm 121-1 and the second diaphragm 121-2. The main region 121a may move in the vibration direction under a driving force generated by a cooperation of the magnetic circuit assembly and the voice coil assembly in the loudspeaker 120, thereby generating a sound by pushing or compressing air inside the first housing 110 or air inside the loudspeaker 120. The surround region 121b may generate an elastic deformation with the movement of the main region 121a, to provide an elastic restoring force for the main region 121a.

Since the first diaphragm 121-1 and the second diaphragm 121-2 are spaced apart in the vibration direction, the magnetic circuit assembly may be disposed between the first diaphragm 121-1 and the second diaphragm 121-2, and the first diaphragm 121-1 and the second diaphragm 121-2 may share the magnetic circuit assembly, thereby reducing a quantity of components and lowering hardware cost.

In some embodiments, the main region 121a of the first diaphragm 121-1 and the main region 121a of the second diaphragm 121-2 have a first interval distance L1 along the vibration direction. An inner wall surface of the inside wall 110a and an inner wall surface of the outside wall 110b have a second interval distance L2 that is a farthest distance along the vibration direction. A ratio of the first interval distance L1 to the second interval distance L2 is more than or equal to 70%. For example, the ratio of the first interval distance L1 to the second interval distance L2 may be 70%, 75%, 80%, 85%, 90%, or the like.

Such a configuration can reduce distances between the first diaphragm 121-1 and the inside wall 110a and between the second diaphragm 121-2 and the outside wall 110b as much as possible, which is beneficial for reducing the volumes of the first acoustic cavity 111-1 and the second acoustic cavity 111-2, increasing the resonance frequency of the first Helmholtz resonator model, which in turn causes the second resonance peak to shift towards a high frequency, thereby increasing the frequency band width of active noise cancellation, and increasing the resonance frequency of the second Helmholtz resonator model, causing the third resonance peak to shift towards a high frequency, and reducing the influence of vibrations generated by the second Helmholtz resonator model on the frequency band width of active noise cancellation.

The impact of the specific settings of the sound outlets on the high-frequency resonant peak of the frequency response curve of the headphone will be discussed in detail below. It should be noted that the high-frequency resonant peak, the high-frequency peak, or the like, described below, refers to the second resonant peak of the sound output through the first sound outlet 112-1 in some embodiments.

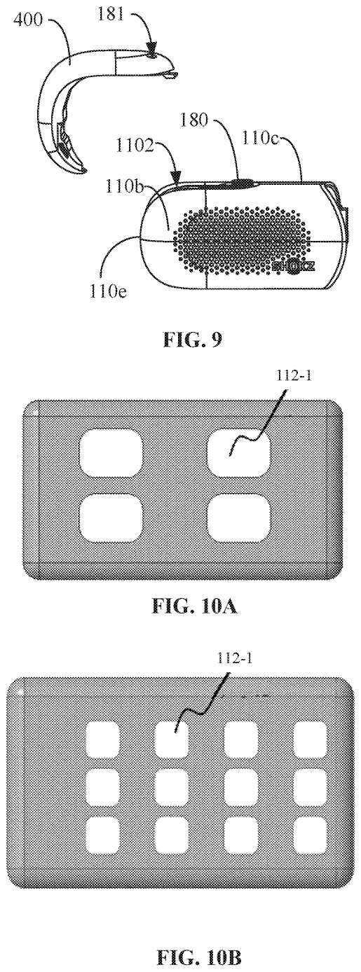

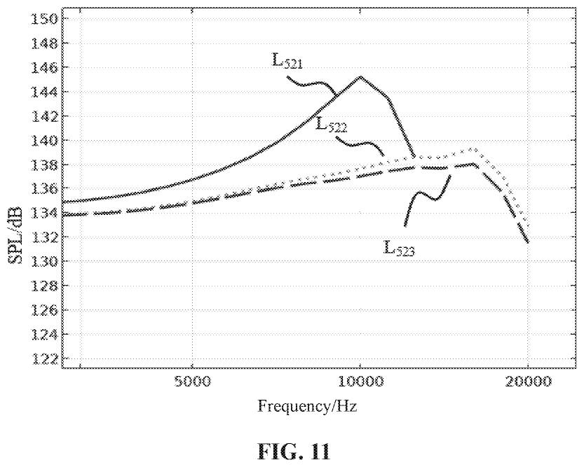

Referring to FIG. 10A, FIG. 10B, and FIG. 11; FIG. 10A and FIG. 10B are schematic diagrams illustrating different quantities of sound outlets according to some embodiments of the present disclosure. The total opening areas of the sound outlets shown in FIG. 10A and FIG. 10B are the same, that is, the opening rates are the same. The calculation formula for an opening rate refers to a ratio of the total opening area of the sound outlets to an area of the corresponding housing sidewall of the first housing 110. For example, an opening rate of the first sound outlet 112-1 is a ratio of an area of the first sound outlet 112-1 to an area of the inside wall 110a.

FIG. 11 is a schematic diagram illustrating frequency response curves of a loudspeaker corresponding to different quantities of sound outlets according to some embodiments of the present disclosure. In FIG. 11, the curve L521 represents a frequency response of the sound generating unit 100 corresponding to a single sound outlet with an opening rate of 0.25; the curve L522 represents a frequency response of the sound generating unit 100 corresponding to the sound outlets shown in FIG. 10A, which are array-arranged openings with large meshes and an opening rate of 0.2178; and the curve L523 represents a frequency response of the sound generating unit 100 corresponding to the sound outlets shown in FIG. 10B, which are array-arranged openings with small meshes and an opening rate of 0.2178.

Referring to FIG. 11, comparing the curve L521, the curve L522, and the curve L523, as the size of a single sound outlet decreases and a quantity of the sound outlets increases, a resonant peak of a corresponding curve in a high frequency band moves to a higher frequency. Therefore, by configuring the first sound outlet 112-1 to include a plurality of first micro-holes arranged in an array, and the second sound outlet 112-2 to include a plurality of second micro-holes arranged in an array, the present disclosure allows the high-frequency peak of the loudspeaker 120 to move to a high frequency, thereby ensuring an active noise cancellation effect, preventing foreign objects from entering, and meeting appearance design requirements of the sound generating unit 100 and/or the headphone.

Referring to FIG. 11, comparing the curve L521, the curve L522, and the curve L523, as the size of a single sound outlet decreases and a quantity of the sound outlets increases, the output sound pressure level of a corresponding curve in a high frequency band decreases. When the opening rate is constant, if the size of the single sound outlet is too small, although the total quantity of the sound outlets may be increased, thereby increasing the high-frequency resonant peak, it may also increase an acoustic resistance of the sound outlets, thereby affecting the output sound pressure level. Therefore, to ensure the output sound pressure level of the first sound outlet 112-1, the aperture diameter of a single first micro-hole may not be less than 0.2 mm. The “first micro-hole”, the “second micro-hole”, or the like, referred to in the present disclosure, may be a regular circular hole, or may be an elliptical hole, a polygonal hole, or the like. The “aperture diameter” referred to in the present disclosure refers to a maximum value of a distance between any two points on the edge of the micro-hole.

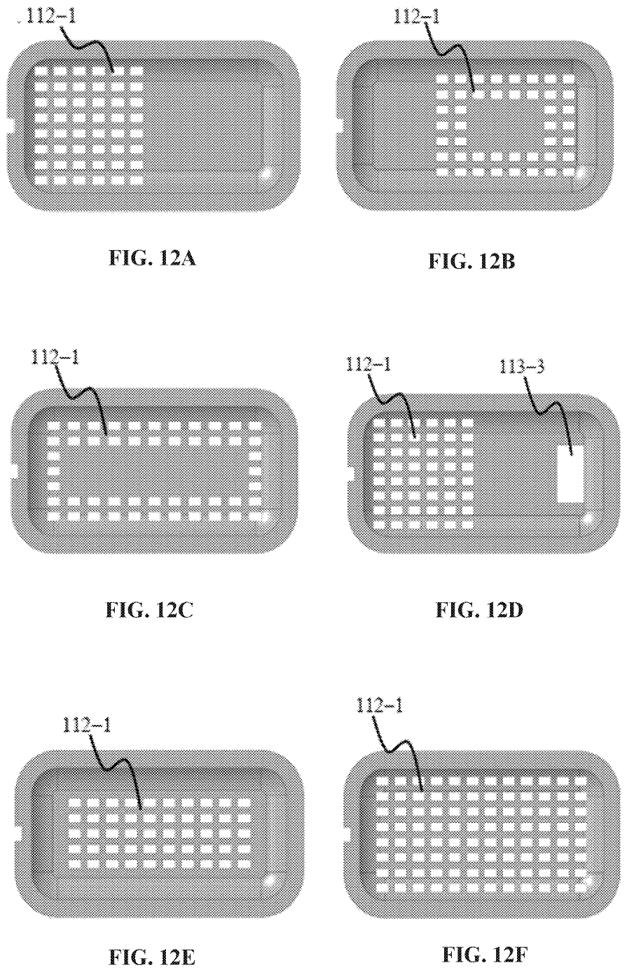

Referring to FIG. 12A to FIG. 12F, FIG. 12A to FIG. 12F are schematic diagrams illustrating exemplary sound outlets with array openings distributed in different configurations according to some embodiments of the present disclosure. FIG. 12A shows the sound outlets distributed on a side of a corresponding housing sidewall of the first housing 110 in the long axis direction, and a corresponding opening rate is 0.15. FIG. 12B shows the sound outlets annularly distributed on a side of the corresponding housing sidewall of the first housing 110 in the long axis direction, and a corresponding opening rate is 0.15. FIG. 12C shows the sound outlets annularly distributed on an entire surface of the corresponding housing sidewall of the first housing 110, and a corresponding opening rate is 0.15. FIG. 12D shows the sound outlets annularly distributed on a side of the corresponding housing sidewall of the first housing 110 in the long axis direction, and a pressure relief hole is disposed on another side of the corresponding housing sidewall in the long axis direction, a corresponding opening rate of the sound outlets is 0.15, and a corresponding opening rate of the pressure relief hole is 0.0375. FIG. 12E shows the sound outlets distributed in a central region of the corresponding housing sidewall of the first housing 110, and a corresponding opening rate is 0.15. FIG. 12F shows the sound outlets distributed on the entire surface of the corresponding housing sidewall of the first housing 110, and a corresponding opening rate is 0.30.

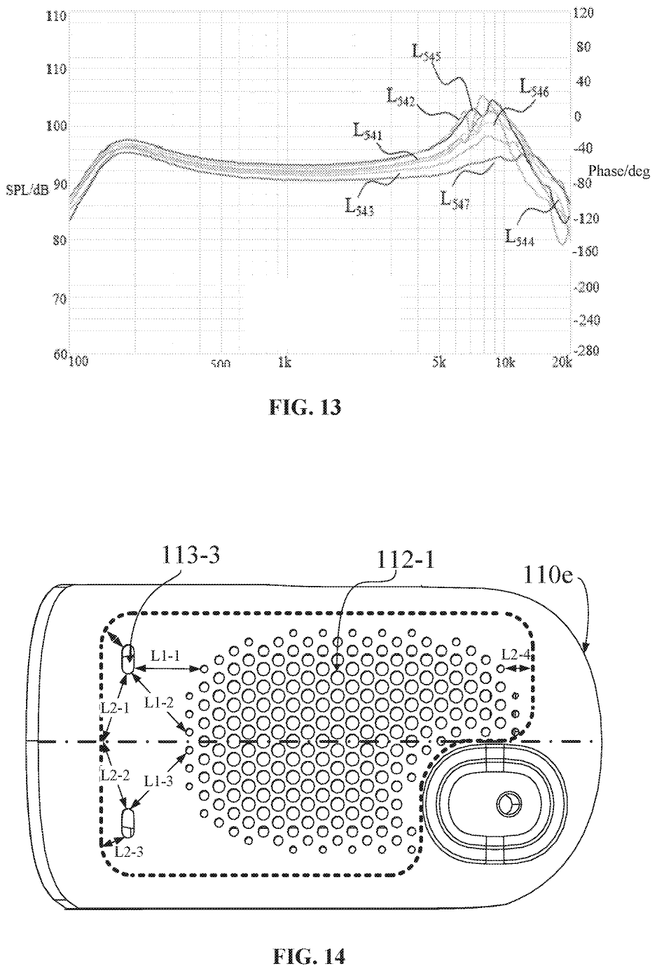

Referring to FIG. 13, FIG. 13 is a schematic diagram illustrating frequency response curves of the sound generating unit 100 corresponding to sound outlets with different distributions according to some embodiments of the present disclosure. The curve L541 corresponds to the sound outlets shown in FIG. 12C; the curve L542 corresponds to the sound outlets shown in FIG. 12B; the curve L543 corresponds to a fully perforated housing sidewall of the first housing 110, with an opening rate of 1; the curve L544 corresponds to the sound outlets shown in FIG. 12D; the curve L545 corresponds to the sound outlets shown in FIG. 12E; the curve L546 corresponds to the sound outlets shown in FIG. 12F; and the curve L547 corresponds to the loudspeaker 120 without the first housing 110.

Referring to FIG. 13, comparing the curve L546 and the curve L543, the positions of the high-frequency peaks are substantially the same, and both are at about 8.3 kHz. Comparing the curve L541, the curve L542, the curve L544, and the curve L545 with the curve L543, the high-frequency peaks of curve L541, curve L542, curve L544, and curve L545, which have an opening rate of 0.15, all have frequencies lower than the frequency of the high-frequency peak of the curve L546, which has an opening rate of 0.3. Comparing the curve L541, the curve L542, the curve L544, and the curve L545, all of which have an opening rate of 0.15, the high-frequency peak of the curve L544 is located at about 8.3 kHz and has an additional resonant peak at about 6.5 kHz; the high-frequency peak of curve L541 is located at about 8.3 kHz and has an additional resonant peak at about 6.1 kHz; the high-frequency peak of curve L545 is located at about 7.1 kHz; and the high-frequency peak of curve L542 is located at about 6.5 kHz. When the opening rate of the sound outlets is 0.15, the high-frequency peaks corresponding to the curve L541, the curve L542, the curve L544, and the curve L545 are all higher than 6 kHz.

Based on this, in some embodiments, when the sound outlets are a plurality of micro-holes arranged in an array, to allow the headphone to have a flatter output in a wider frequency band range, the opening rate of the sound outlets may be not less than 0.1. Therefore, a ratio of the total opening area of the first sound outlet 112-1 to an area of the inside wall 110a may be not less than 10%, and a ratio of the total opening area of the second sound outlet 112-2 to an area of the outside wall 110 b may be not less than 10%.

For example, when the opening rate of the sound outlets is 0.15, the high-frequency peaks corresponding to the curve L541, the curve L542, the curve L544, and the curve L545 are all higher than 6 kHz. At this time, the headphone has a flatter output in a wider frequency band range, thereby allowing the headphone to have a better active noise cancellation effect. As another example, the opening rate of the sound outlets may not be less than 0.3. This may further allow the headphone to have a flatter output in an even wider frequency band range, thereby causing the high-frequency peak of the frequency response output by the sound outlets to be higher than 8 kHz.

The first sound outlet 112-1 includes a plurality of first micro-holes arranged in an array. To allow the second resonant peak to move to a high frequency as much as possible, thereby increasing the bandwidth of the active noise cancellation and ensuring the output sound pressure level of the first sound outlet 112-1, to ensure the listening effect of the user, the aperture diameter of a single first micro-hole may be set to be not less than 0.2 mm. For example, the aperture diameter of the single first micro-hole may be set to 0.2 mm, 0.5 mm, 0.8 mm, 1 mm, 1.5 mm, 2 mm, or even larger. An interval distance between two adjacent first micro-holes may be between 0.2 mm and 4 mm. For example, the interval distance between the two adjacent first micro-holes may be 0.2 mm, 0.5 mm, 0.8 mm, 1 mm, 1.5 mm, 2 mm, or 4 mm. The second sound outlet 112-2 includes a plurality of second micro-holes arranged in an array. To reduce an impact of vibration generated by the second Helmholtz resonance cavity model on a bandwidth of the active noise cancellation, the aperture diameter of a single second micro-hole may be set to be not less than 0.2 mm. For example, the aperture diameter of the single second micro-hole may be set to 0.2 mm, 0.5 mm, 0.8 mm, 1 mm, 1.5 mm, 2 mm, or even larger. The interval distance between two adjacent second micro-holes may be between 0.2 mm to 4 mm. For example, the interval distance between the two adjacent second micro-holes may be 0.2 mm, 0.5 mm, 0.8 mm, 1 mm, 1.5 mm, 2 mm, or 4 mm.

It should be noted that the “between A and B” referred to in the present disclosure includes endpoints A and B. The “interval distance between two first micro-holes” referred to in the present disclosure refers to a minimum distance between contour edges of the two first micro-holes. The “interval distance between two second micro-holes” referred to in the present disclosure refers to a minimum distance between contour edges of the two second micro-holes.

As described above, in some embodiments, the first housing 110 is an integral metal component. By configuring the first housing 110 as a metal component, the inside wall 110a and the outside wall 110b have a relatively large strength, allowing the plurality of first micro-holes arranged in an array and the plurality of second micro-holes arranged in an array to be formed, thereby ensuring that the first sound outlet 112-1 has a relatively large total opening area, and the second sound outlet 112-2 has a relatively large total opening area. In some embodiments, to ensure that the inside wall 110a and the outside wall 110b have a sufficient strength, the thickness of the inside wall 110 a and the thickness of the outside wall 110 b may be between 0.2 mm and 1 mm. For example, the thickness of the inside wall 110 a may be 0.2 mm, 0.4 mm, 0.5 mm, 0.6 mm, 0.8 mm, or 1 mm, and the thickness of the outside wall 110 b may be 0.2 mm, 0.4 mm, 0.5 mm, 0.6 mm, 0.8 mm, or 1 mm.

In some embodiments, the total opening area of the plurality of second micro-holes is greater than the total opening area of the plurality of first micro-holes, that is, the total opening area of the second sound outlet 112-2 may be greater than the total opening area of the first sound outlet 112-1.

For example, when the resonant frequency of the second Helmholtz resonance cavity model is H1, the frequency response curve of the sound output by the second sound outlet 112-2 has a resonant peak near the frequency H1. In addition to being output via the second sound outlet 112-2, the vibration generated by the second Helmholtz resonance cavity model is superimposed onto the sound output by the first sound outlet 112-1 with synchronous vibrations of the first diaphragm and the second diaphragm, thereby causing the frequency response curve output by the first sound outlet 112-1 to have a resonant peak near the frequency H2, wherein the frequency H2 is typically less than the frequency H1. When the frequency H2 is greater than the peak resonant frequency of the second resonant peak (which is approximately equal to the resonant frequency of the first Helmholtz resonance cavity model), the impact of the vibration generated by the second Helmholtz resonance cavity model on the bandwidth of the active noise cancellation can be reduced as much as possible.

Therefore, by configuring the total opening area of the second sound outlet 112-2 to be greater than the total opening area of the first sound outlet 112-1, this allows the resonant frequency of the second Helmholtz resonance cavity model to be greater than the resonant frequency of the first Helmholtz resonance cavity model, thereby causing the third resonant peak to move to a high frequency, which is beneficial for reducing an impact of the vibration generated by the second Helmholtz resonance cavity model on the bandwidth of the active noise cancellation as much as possible.

In some embodiments, the quantity of the plurality of second micro-holes is greater than the quantity of the plurality of first micro-holes.

Inside the loudspeaker 120, the first sound outlet 112-1 disposed on the inside wall 110a may output a sound, and the second sound outlet 112-2 disposed on the outside wall 110b may also output a sound. The loudspeaker 120 as a whole may be equivalent to a dipole sound source. By configuring the second sound outlet 112-2 to have a greater quantity of the second micro-holes, the output sound pressure level of the second sound outlet 112-2 can be reduced, thereby reducing an impact of the sound output by the second sound outlet 112-2 on the active noise cancellation, and further allowing the acoustic zero point of the dipole sound source to shift to a side where the outside wall 110b is located.

Referring to FIG. 5, in some embodiments, the sound generating assembly further includes a first acoustic resistance mesh 160-1 and a second acoustic resistance mesh 160-2. The first acoustic resistance mesh 160-1 is disposed at the first sound outlet 112-1 and inside the first acoustic cavity 111-1, the second acoustic resistance mesh 160-2 is disposed at the second sound outlet 112-2 and inside the second acoustic cavity 111-2, and a specific acoustic impedance of the first acoustic resistance mesh 160-1 is less than a specific acoustic impedance of the second acoustic resistance mesh 160-2. The first acoustic resistance mesh 160-1 may cover the first sound outlet 112-1, and the second acoustic resistance mesh 160-2 may cover the second sound outlet 112-2, thereby playing a role in dust prevention, waterproofing, or the like.

By configuring the specific acoustic impedance of the first acoustic resistance mesh 160-1 to be less than the specific acoustic impedance of the second acoustic resistance mesh 160-2, the output sound pressure level of the second sound outlet 112-2 can be reduced, thereby reducing an impact of the sound output by the second sound outlet 112-2 on the active noise cancellation, and further allowing the acoustic zero point of the dipole sound source to shift to a side where the outside wall 110b is located. In some embodiments, a ratio of the specific acoustic impedance of the second acoustic resistance mesh 160-2 to the specific acoustic impedance of the first acoustic resistance mesh 160-1 is not less than 10. For example, the ratio may be 10, 30, 50, 60, 70, 80, 100, or even larger. For example, the specific acoustic impedance of the first acoustic resistance mesh 160-1 is less than 10 Rayl, and the specific acoustic impedance of the second acoustic resistance mesh 160-2 is greater than 700 Rayl. As described above, the headphone further includes the microphone assembly. The microphone assembly may be configured to collect the ambient noise, and the headphone is configured to adjust an output of the loudspeaker 120 based on the ambient noise collected by the microphone assembly to achieve active noise cancellation. A sound pickup hole acoustically connected to the microphone assembly may be disposed on the sound generating unit 100 and/or the adapter section 300. To avoid the sound emitted by the loudspeaker 120 from being collected by the sound pickup hole, the sound pickup hole may be disposed near the acoustic zero point of the dipole sound source.

In addition, when the sound pickup hole is disposed close to the inside wall 110a in the thickness direction, it may be blocked by the ear, which is not conducive to collecting the ambient noise. When the sound pickup hole is disposed close to the outside wall 110b in the thickness direction, the position is relatively open, thereby reducing blocking by the ear.

By causing the acoustic zero point of the dipole sound source to shift to a side where the outside wall 110b is located, the sound pickup hole may be disposed close to the outside wall 110b and is located near the acoustic zero point of the dipole sound source. In this manner, not only can the blocking of the sound pickup hole by the ear be reduced, but also the sound emitted by the loudspeaker 120 can be prevented from being collected by the sound pickup hole, thereby allowing the sound pickup hole to collect high-quality ambient noise.

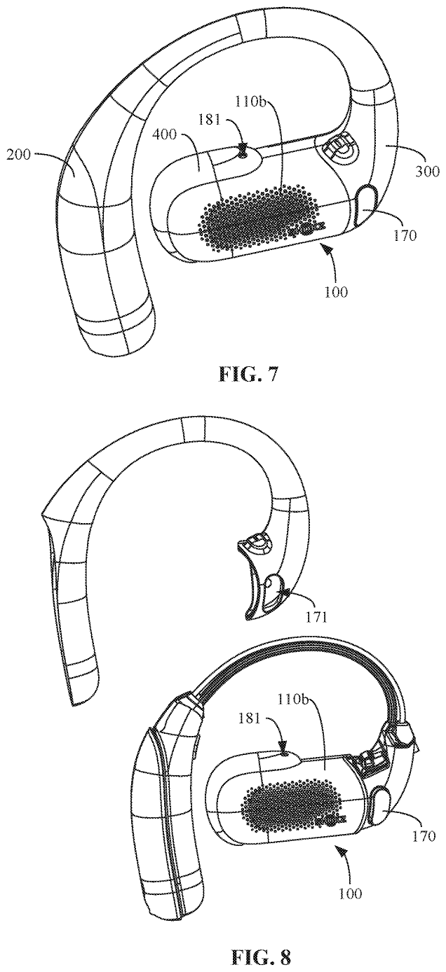

Referring collectively to FIG. 7 and FIG. 8, in some embodiments, the microphone assembly includes a first microphone assembly 170. The first microphone assembly 170 is disposed inside the adapter section 300. The adapter section 300 is provided with a first sound pickup hole 171 on a side close to the outside wall 110b along the vibration direction. The first microphone assembly 170 collects the ambient noise through the first sound pickup hole 171, and the headphone is configured to adjust the output of the loudspeaker 120 based on the ambient noise collected by the first microphone assembly 170 to achieve active noise cancellation. On one hand, the first sound pickup hole 171 is disposed on the adapter section 300 relatively away from the ear and is disposed close to the outside wall 110b, thereby reducing blocking by the ear. On the other hand, the first sound pickup hole 171 is disposed on a side close to the outside wall 110b and is located near the acoustic zero point of the dipole sound source, thereby preventing the sound emitted by the loudspeaker 120 from being collected by the first sound pickup hole 171, and allowing the first sound pickup hole 171 to collect the high-quality ambient noise.

Referring collectively to FIG. 7, FIG. 8, and FIG. 9, in some embodiments, the microphone assembly includes a second microphone assembly 180. A portion of the second microphone assembly 180 is accommodated inside the first housing 110 via a second opening 1102 on the upside wall 110c, and another portion of the second microphone assembly 180 protrudes outside the first housing 110, to reduce the occupation of an internal space of the first housing 110, thereby allowing an overall size of the first housing 110 to be set to be relatively small. The portion of the second microphone assembly 180 protruding outside the first housing 110 may be covered by the protrusion 400. The protrusion 400 is provided with a second sound pickup hole 181 on a side close to the outside wall 110b. The second microphone assembly 180 collects the ambient noise through the second sound pickup hole 181, and the headphone is configured to adjust the output of the loudspeaker 120 based on the ambient noise collected by the second microphone assembly 180 to achieve active noise cancellation. The second sound pickup hole 181 is disposed on a side of the protrusion 400 close to the outside wall 110b and is located near the acoustic zero point of the dipole sound source, thereby reducing the blocking of the second sound pickup hole 181 by the ear, preventing the sound emitted by the loudspeaker 120 from being collected by the second sound pickup hole 181, and allowing the second sound pickup hole 181 to collect the high-quality ambient noise.

The second microphone assembly 180 is disposed on the upside wall 110c of the first housing 110, is closer to the ear canal than the first microphone assembly 170, and is more significantly obstructed by the ear. In some embodiments, when the headphone detects that wind noise is relatively large, the second microphone assembly 180 may be enabled to collect the ambient noise, and the first microphone assembly 170 may be disabled, to reduce the impact of wind noise. When the headphone detects that the wind noise is relatively small, the first microphone assembly 170 may be enabled to collect the ambient noise.

As shown in FIG. 6 and FIG. 14, in some embodiments, an end of the sound generating unit 100 away from the ear hook at least partially extends into the concha cavity 12, and an end wall 110e is disposed at an end of the first housing 110 away from the ear hook. The first sound outlet 112-1 may be disposed close to the end wall 110e. In this manner, the first sound outlet 112-1 can be closer to the ear canal, thereby improving the listening effect of the user and reducing sound leakage.

In the wearing state, because the first sound outlet 112-1 is located on a side close to the ear canal 11, and is limited by factors such as an opening size of the first sound outlet 112-1 and a covering area relative to the first acoustic cavity 111-1, a portion of sounds generated by the loudspeaker 120 (specifically, the first diaphragm 121-1) in the first acoustic cavity 111-1 may be obstructed by a housing sidewall of the first housing 110 (e.g., a portion of the inside wall 110a not provided with the first sound outlet 112-1) and cannot be directly output through the first sound outlet 112-1. This may cause standing waves to be formed in the first acoustic cavity 111-1, which may lead to a forward shift of the peak resonant frequency of the second resonant peak (i.e., a shift to a low frequency), thereby affecting the active noise cancellation performance of the headphone within a wide frequency range.

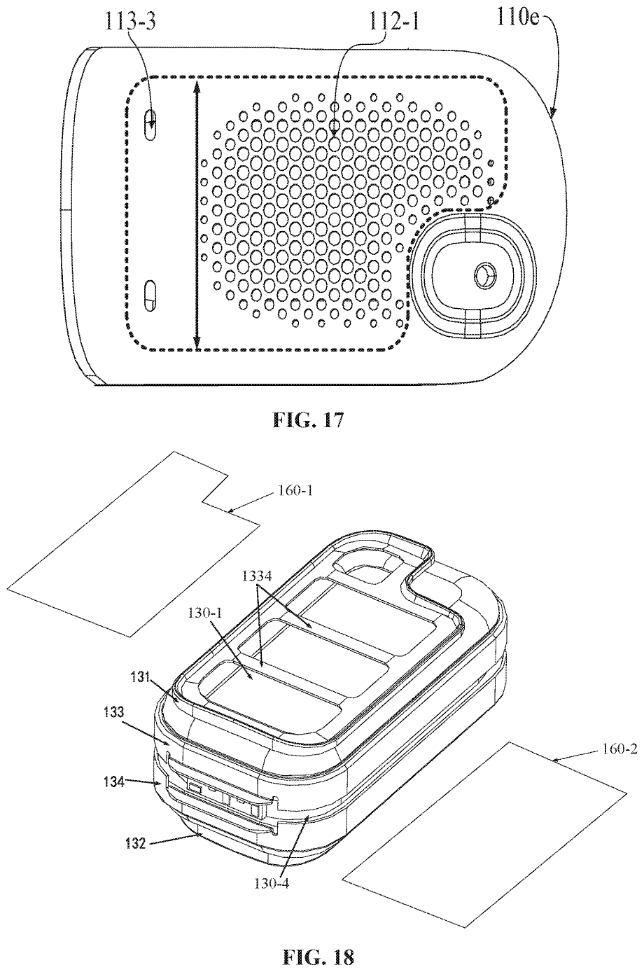

Therefore, in some embodiments, referring to FIG. 6, FIG. 12D, FIG. 14, and FIG. 17, the inside wall 110a is further provided therethrough with a sound tuning hole 113-3, and the sound tuning hole 113-3 is acoustically connected to the first acoustic cavity 111-1. Based on a connection relationship between the first sound outlet 112-1 and the sound tuning hole 113-3 and the first acoustic cavity 111-1, the peak resonant frequency of the second resonant peak of the sound output through the first sound outlet 112-1 to an outside of the first housing 110 may be adjusted by means of the sound tuning hole 113-3, for example, such that the peak resonant frequency of the second resonant peak is not less than 1 kHz.

Specifically, a majority of the sound generated by the loudspeaker 120 in the first acoustic cavity 111-1 is output through the first sound outlet 112-1, while a minority of the sound may be output through the sound tuning hole 113-3, thereby minimizing the formation of standing waves in the first acoustic cavity 111-1. This allows the peak resonant frequency of the second resonant peak of the frequency response curve of the sound output through the first sound outlet 112-1 to shift as much as possible to a high frequency, achieving an adjustment of the peak resonant frequency of the resonant peak, and ultimately allowing the headphone to have a relatively flat output within a wider frequency range, which facilitates the active noise cancellation of the headphone within the wide frequency range. In some embodiments, the first acoustic resistance mesh 160-1 may cover the first sound outlet 112-1 and the sound tuning hole 113-3, to provide dustproof, waterproof, or the like.

Considering that different relative positions between the sound tuning hole 113-3 and the first sound outlet 112-1 may affect the output of the loudspeaker 120 or the position of the peak resonant frequency of the resonant peak, referring to FIG. 14, taking an example where both the first sound outlet 112-1 and the sound tuning hole 113-3 adopt a porous structure, L1-X refers to a minimum distance between the first sound outlet 112-1 and the sound tuning hole 113-3, and L2-X refers to a minimum distance between the boundary of the first acoustic cavity 111-1 and the first sound outlet 112-1 or the sound tuning hole 113-3. It should be noted that the minimum distance referred to herein refers to a distance between contour edges of any two holes, or a distance from a contour edge of any hole to a boundary of an acoustic cavity.

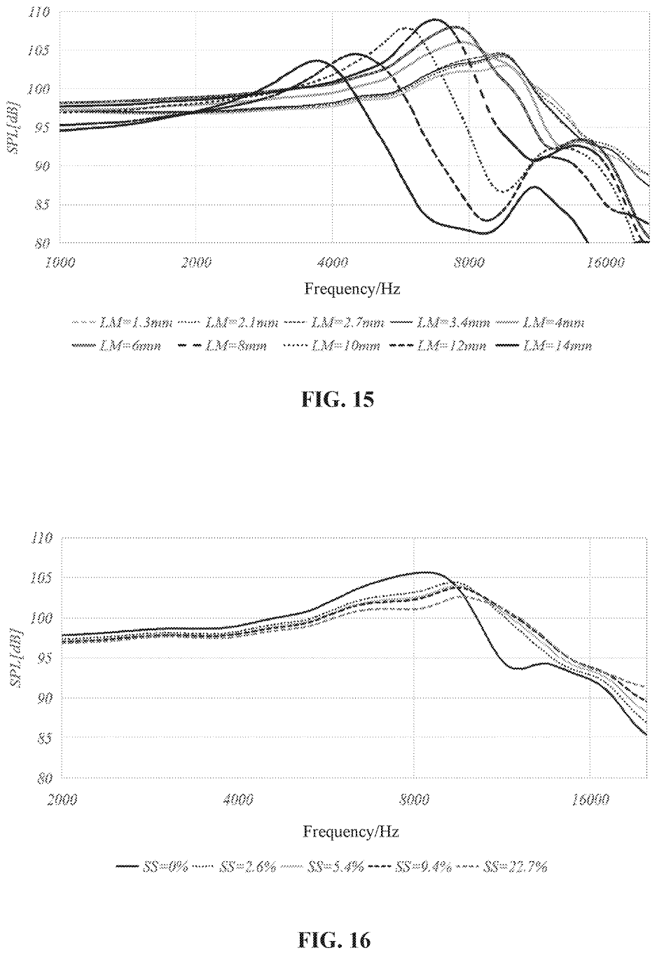

Referring to FIG. 15, FIG. 15 is a schematic diagram illustrating exemplary response curves of the sound generating unit 100 corresponding to different L1-X values and L2-X values according to some embodiments of the present disclosure. In FIG. 15, LM is L1-X or L2-X.

As shown in FIG. 15, the high frequency peak corresponding to LM=1.3 mm is 9.5 kHz, the high frequency peak corresponding to LM=2.1 mm is 9.25 kHz, the high frequency peak corresponding to LM=2.7 mm is 9 kHz, the high frequency peak corresponding to LM=3.4 mm is 8.75 kHz, the high frequency peak corresponding to LM=4 mm is 7.75 kHz, the high frequency peak corresponding to LM=6 mm is 7.5 kHz, the high frequency peak corresponding to LM=8 mm is 6.7 kHz, the high frequency peak corresponding to LM=10 mm is 5.8 kHz, the high frequency peak corresponding to LM=12 mm is 4.5 kHz, and the high frequency peak corresponding to LM=14 mm is 3.65 kHz. As LM increases, the corresponding high frequency peak shifts forward sequentially, which means that the total opening area decreases accordingly, thereby causing a decrease in the sound pressure level of the sound output from a side of the inside wall 110a. When LM=14 mm, compared to other smaller LM values, the sound pressure level at 1 kHz decreases by 3 dB, which is an acceptable state.

Therefore, in some embodiments, when both the first sound outlet 112-1 and the sound tuning hole 113-3 adopt a porous structure, the minimum distance between the first sound outlet 112-1 and the sound tuning hole 113-3 is not greater than 14 mm, the minimum distance from the boundary of the first acoustic cavity 111-1 to the first sound outlet 112-1 is not greater than 14 mm, and the minimum distance from the boundary of the first acoustic cavity 111-1 to the sound tuning hole 113-3 is not greater than 14 mm.

In this manner, the sound output from the first sound outlet 112-1 may have a relatively flat phase curve at least within a frequency range prior to 1 kHz, thereby ensuring that the headphone has a relatively flat output within the wide frequency range, to facilitate the active noise cancellation of the headphone within the wide frequency range. Additionally, as described in the preceding embodiments, the aperture diameter of each micro-hole included in the first sound outlet 112-1 and the sound tuning hole 113-3 may be set to be not less than 0.2 mm.

In some embodiments, any one of the aforementioned minimum distances may be set to be not greater than 10 mm, not greater than 8 mm, not greater than 6 mm, or not greater than 3.4 mm. For example, when the minimum distance is 10 mm, the peak resonant frequency of the second resonant peak may be adjusted to 5.8 kHz; when the minimum distance is 8 mm, the peak resonant frequency of the second resonant peak may be adjusted to 6.7 kHz; when the minimum distance is 6 mm, the peak resonant frequency of the second resonant peak may be adjusted to 7.5 kHz; and when the minimum distance is 3.4 mm, the peak resonant frequency of the second resonant peak may be adjusted to 8.75 kHz. In this manner, by selectively setting the minimum distance, the peak resonant frequency of the second resonant peak may be shifted as much as possible to a high frequency, further widening the flat region of the frequency response curve, allowing the headphone to achieve active noise cancellation within a wider frequency range.

In some embodiments, a ratio of a total area of the sound tuning hole 113-3 to a total area of the first sound outlet 112-1 may be set to be less than 23%. Specifically, referring to FIG. 16, FIG. 16 is a schematic diagram illustrating exemplary frequency response curves of the sound generating unit 100 under different area ratios between the sound tuning hole 113-3 and the first sound outlet 112-1 according to some embodiments of the present disclosure. On a reference plane perpendicular to the thickness direction, a total projection area of the first sound outlet 112-1 on the reference plane refers to S1, a total projection area of the sound tuning hole 113-3 on the reference plane refers to S2, and a ratio of the total projection area S2 of the sound tuning hole 113-3 to the total projection area S1 of the first sound outlet 112-1 refers to SS.

As shown in FIG. 16, as SS gradually increases, the high frequency peak gradually shifts backward, and the sound pressure level of the output sound gradually decreases; an increase in SS means that the total opening area of the sound tuning hole 113-3 increases, which may effectively achieve a pressure relief effect, thereby causing the high frequency peak to shift backward. However, at the same time, due to the increase in the total opening area of the sound tuning hole 113-3, the sound leaked through the sound tuning hole 113-3 also increases, thereby causing a decrease in the sound pressure level of the sound output through the first sound outlet 112-1. It can be seen from FIG. 16 that, when SS is from 0% (i.e., the sound tuning hole 113-3 is not provided) to 22.7%, the high frequency peak shifts backward from 8.5 kHz to 9.75 kHz, and at the same time, the sound pressure level of the output sound decreases by 1 dB, which is within an acceptable range.

Therefore, setting the ratio of the total area of the sound tuning hole 113-3 to the total area of the first sound outlet 112-1 to be less than 23% may effectively avoid too much sound leaking from the sound tuning hole 113-3 due to an excessive opening or an excessive area proportion of the sound tuning hole 113-3, thereby causing problems of a decrease in the sound pressure level or a reduction in the volume of the first sound outlet 112-1.

In some embodiments, the ratio of the total area of the sound tuning hole 113-3 to the total area of the first sound outlet 112-1 is set to 22.7%, thereby allowing the peak resonant frequency of the second resonant peak to be adjusted to around 9.75 kHz, further widening the width of the flat region of the frequency response curve of the sound output through the first sound outlet 112-1, so that the headphone may perform active noise cancellation within a wider frequency range.

In some embodiments, referring to FIG. 17, the sound tuning hole 113-3 is configured to be at a position farther from the end wall 110e compared to the first sound outlet 112-1. In this manner, in the wearing state, the sound tuning hole 113-3 is located at a position farther from the ear canal 11 compared to the first sound outlet 112-1. In an open-ear application scenario, because the ambient noise received by the user's ear canal 11 is relatively large, improving the output performance of the headphone helps the headphone perform active noise cancellation for the relatively large ambient noise. Therefore, by configuring the sound tuning hole 113-3 to be at a position farther from the ear canal 11 compared to the first sound outlet 112-1, the sound output through the sound tuning hole 113-3 and the sound output through the first sound outlet 112-1 may undergo far-field destructive interference, to reduce sound leakage of the headphone and ensure a listening effect for the user.

For example, on a reference plane perpendicular to the thickness direction, a length of a projection of the first acoustic cavity 111-1 in the long axis direction is not less than a width thereof in the short axis direction. For example, the projection shape of the first acoustic cavity 111-1 may be a rectangle where the length is greater than the width, or the projection shape of the first acoustic cavity 111-1 may be a square where the length is equal to the width or a circle. The projection of the first acoustic cavity 111-1 on the reference plane is divided into a first region and a second region along a length direction. A ratio of a length of the first region in the long axis direction to a length of the projection of the first acoustic cavity 111-1 in the long axis direction may be set to be less than 40%, e.g., 38.3%. A projection of the sound tuning hole 113-3 on the reference plane is located in the first region, and a projection of the first sound outlet 112-1 on the reference plane is located in the second region.

In this manner, by configuring the sound tuning hole 113-3 and the first sound outlet 112-1 in different regions of the inside wall 110a corresponding to the first acoustic cavity 111-1, it is possible to both ensure that the sound tuning hole 113-3 is located at a position farther from the ear canal compared to the first sound outlet 112-1 in the wearing state, and distinguish between the sound tuning hole 113-3 and the first sound outlet 112-1 when the sound tuning hole 113-3 adopts an array of micro-holes or a large-area concentrated opening and is relatively close to the first sound outlet 112-1. For example, in the length direction or a diameter direction of the first acoustic cavity 111-1, holes within a region with a proportion of 38.3% from the boundary of the first acoustic cavity 111-1 may be regarded as the sound tuning hole 113-3.

It should be noted that a bold dashed line in FIG. 14 and FIG. 17 represents a projection boundary of the first acoustic cavity 111-1 on the reference plane. A bold solid line with an arrow in FIG. 17 represents an approximate boundary between the first region and the second region in the projection shape of the first acoustic cavity 111-1, wherein a region located to a left side of the bold solid line represents the first region, and a region located to a right side of the bold solid line represents the second region.

In some embodiments, the first sound outlet 112-1 includes a plurality of first micro-holes arranged in an array, and an interval distance between the sound tuning hole 113-3 and a nearest first micro-hole is more than or equal to 5 times an interval distance between adjacent first micro-holes.

In some embodiments, referring to FIG. 14 and FIG. 17, when the first sound outlet 112-1 is a porous structure composed of a plurality of micro-holes arranged in an array, an aperture diameter of a micro-hole located in a region of the inside wall 110a directly facing the ear canal 11 in the wearing state is set to be larger than an aperture diameter of a micro-hole located in other regions of the inside wall 110a. Illustratively, among the plurality of micro-holes of the sound outlet 112-1, the aperture diameter of the micro-holes close to the boundary of the first acoustic cavity 111-1 and the sound tuning hole 113-3 is less than the aperture diameter of the micro-holes at other positions. In this manner, by differentially setting the aperture diameters of the plurality of micro-holes in the first sound outlet 112-1, the sound pressure level of the sound output by the headphone from a portion directly facing the ear canal 11 may be increased, thereby ensuring the user's listening effect.

Referring to FIG. 5 and FIG. 6, the sound generating assembly may further include the limiting assembly 130. The limiting assembly 130 may be configured to sealingly fix the loudspeaker 120 inside the first housing 110. In addition, the limiting assembly 130 may also be configured to cooperate with the loudspeaker 120 and corresponding housing sidewalls of the first housing 110 to sealingly form an acoustic cavity. Specifically, the loudspeaker 120 is spaced apart from the inside wall 110a and the outside wall 110b along the vibration direction. The limiting assembly 130 positions and limits the loudspeaker 120 between the inside wall 110a and the outside wall 110b, thereby cooperating with the loudspeaker 120 and the inside wall 110a to sealingly form the first acoustic cavity 111-1, and cooperating with the loudspeaker 120 and the outside wall 110b to sealingly form the second acoustic cavity 111-2.

The limiting assembly 130 not only affects a structural relationship between the loudspeaker 120 and the first housing 110, but also affects the structure of the acoustic cavities, thereby affecting the frequency band width of the active noise cancellation. Therefore, referring to FIG. 18 to FIG. 20, a description of the limiting assembly 130 and its related structures will be mainly provided below.

In some embodiments, referring to FIG. 5, the loudspeaker 120 includes the first diaphragm 121-1 and the second diaphragm 121-2 spaced apart along the vibration direction, and the limiting assembly 130 is connected between the loudspeaker 120 and the first housing 110. Illustratively, a portion of the limiting assembly 130 connects the loudspeaker 120 and the inside wall 110a of the first housing 110, and another portion of the limiting assembly 130 connects the loudspeaker 120 and the outside wall 110b of the first housing 110.

When the loudspeaker 120, together with the limiting assembly 130, is installed inside the first housing 110, a connection relationship between the limiting assembly 130 and the housing sidewalls of the first housing 110may be used to allow the first diaphragm 121-1 and the inside wall 110a to be oppositely disposed in the vibration direction and cooperate with the loudspeaker 120 and the inside wall 110a to sealingly form the first acoustic cavity 111-1. It should be noted that the connection may refer to bonding, snap-fitting, or elastic abutment, or the like. The limiting assembly 130 may also allow the second diaphragm 121-2 and the outside wall 110b to be oppositely disposed in the vibration direction and cooperate with the loudspeaker 120 and the outside wall 110b to sealingly form the second acoustic cavity 111-2.

Based on this, the loudspeaker 120 may be firmly limited to a predetermined position inside the first housing 110 by means of the limiting assembly 130, and corresponding acoustic cavities are sealingly formed between the loudspeaker 120 and the first housing 110, thereby creating conditions for improving the output performance of the headphone. At the same time, the limiting assembly 130 may also be combined with the loudspeaker 120 to form a functional monomer with a relatively complete structure (i.e., the sound generating assembly), which is not only beneficial for disassembly and maintenance of the sound generating unit 100, but also beneficial for designing related structures of the first housing 110 (e.g., sound outlets, the sound tuning hole 113-3, or the like) to meet a need for enabling the headphone to perform active noise cancellation within a wider frequency range.

In some embodiments, the limiting assembly 130 may be sealingly connected between the loudspeaker 120 and the first housing 110. Specifically, a portion of the limiting assembly 130 is sealingly connected to the loudspeaker 120, and another portion of the limiting assembly 130 is sealingly connected to the first housing 110. At the same time, a sealed enclosed structure is formed between the inside wall 110a and the first diaphragm 121-1, and a sealed enclosed structure is formed between the outside wall 110b and the second diaphragm 121-2. Illustratively, the limiting assembly 130 is an annular structure with sound guiding holes provided at a center. Along the vibration direction, the sound guiding holes of the limiting assembly 130, the first sound outlet 112-1, the second sound outlet 112-2, the first diaphragm 121-1, and the second diaphragm 121-2 may at least partially overlap.

In some embodiments, the limiting assembly 130 and the loudspeaker 120 are fixedly connected to form an integral structure. One end of the limiting assembly 130 close to the inside wall 110a along the vibration direction elastically abuts against the inside wall 110a, and another end close to the outside wall 110b elastically abuts against the outside wall 110b. As a result, the limiting assembly 130 may be combined with the loudspeaker 120 to form a functional structural body relatively independent of the first housing 110, which is beneficial for reducing the difficulty of disassembly and assembly of the sound generating unit 100.

In some embodiments, referring to FIG. 5, FIG. 6, and FIG. 18 to FIG. 20, the limiting assembly 130 may include a first sealing ring 131 and a second sealing ring 132. The first sealing ring 131 elastically abuts against the inside wall 110a, and the second sealing ring 132 elastically abuts against the outside wall 110b. The first sealing ring 131 and the second sealing ring 132 sealingly fix the loudspeaker 120 inside the first housing 110 from two sides in the vibration direction.

In some embodiments, the limiting assembly 130 may further include a second housing. The loudspeaker 120 is disposed inside the second housing and sealingly cooperates with the second housing to connect. For convenience of distinction and description, a housing wall of the second housing that is spaced apart from the inside wall 110a along the vibration direction refers to a first transverse sidewall 1331, a housing wall of the second housing that is spaced apart from the outside wall 110b along the vibration direction refers to a second transverse sidewall 1341, and a housing wall of the second housing that encloses around the vibration direction refers to a longitudinal sidewall. It may also be understood that the first transverse sidewall 1331 faces the inside wall 110a (or the loudspeaker 120) and is disposed inside the first acoustic cavity 111-1, the second transverse sidewall 1341 faces the outside wall 110b (or the loudspeaker 120) and is disposed inside the second acoustic cavity 111-2, and the loudspeaker 120 is located between the first transverse sidewall 1331 and the second transverse sidewall 1341 along the vibration direction. In addition, one end of the first sealing ring 131 in the vibration direction is fixed to the first transverse sidewall 1331, and another end abuts against the inside wall 110a. One end of the second sealing ring 132 in the vibration direction is fixed to the second transverse sidewall 1341, and another end abuts against the outside wall 110b.

Referring to FIG. 5, based on the first sealing ring 131 and the second sealing ring 132, the sound generating assembly may be sealingly fixed in an interior of the first housing 110 (i.e., an accommodating cavity) by means of an interference fit or the like. For example, the first sealing ring 131 elastically abuts against the inside wall 110a, and the second sealing ring 132 elastically abuts against the outside wall 110b. In this way, by utilizing the first sealing ring 131 and the second sealing ring 132 to sealingly fix the loudspeaker 120 inside the first housing 110 from two sides in the vibration direction, a seal of the first acoustic cavity 111-1 is achieved on a side of the first transverse sidewall 1331 close to the inside wall 110a, and a seal of the second acoustic cavity 111-2 is achieved on a side of the second transverse sidewall 1341 close to the outside wall 110b.

It should be noted that the “boundary of the first acoustic cavity 111-1” as described in the preceding embodiments refers to the first sealing ring 131. That is, it may be understood that on a reference plane perpendicular to the vibration direction, a projection of the first sealing ring 131 on the reference plane is the boundary of the first acoustic cavity 111-1.

In some embodiments, a deformation resistance capability of the first sealing ring 131 and the second sealing ring 132 is less than a deformation resistance capability of the second housing. For example, the first sealing ring 131 and the second sealing ring 132 may be made of elastic materials such as silicone rubber, or the like, and the second housing may be made of metal materials such as aluminum alloy, or the like, or other materials such as plastics, or the like, having a material hardness greater than a material hardness of the sealing rings.

Illustratively, the first sealing ring 131 and the second sealing ring 132 are made of elastic materials such as silicone rubber, or the like, and the first sealing ring 131 and the second sealing ring 132 may be integrally formed on the second housing by means of injection molding, overmolding, or the like. In this way, the limiting assembly 130 may be constructed as a relatively independent and complete structural component, which is beneficial for reducing the difficulty of disassembly and assembly of the sound generating assembly and the sound generating unit 100, and enhancing a structural stability of the sound generating assembly and even the sound generating unit 100.

In some embodiments, a joint of the second housing and the first sealing ring 131 (and the second sealing ring 132) is provided with a reinforcing structure. The reinforcing structure may be a sawtooth structure, a hole structure, or the like, disposed on the first transverse sidewall 1331 or the second transverse sidewall 1341. By means of the reinforcing structure, a robustness of the connection between the first sealing ring 131 (and the second sealing ring 132) and the second housing is enhanced, to prevent the sealing rings from detaching during disassembly and assembly of the sound generating unit 100.

The sound generating assembly may be inserted into the first housing 110 as an entirety through the first opening 1101. After the sound generating assembly is assembled in place relative to the first housing 110, the first sealing ring 131 and the second sealing ring 132 sealingly fix the loudspeaker 120 inside the first housing 110 from two sides in the vibration direction, thereby achieving a seal of the first acoustic cavity 111-1 on a side of the first transverse sidewall 1331 close to the inside wall 110a, and achieving a seal of the second acoustic cavity 111-2 on a side of the second transverse sidewall 1341 close to the outside wall 110b, to achieve assembly in a relatively simple manner, which is beneficial for improving assembly efficiency.

In some embodiments, referring to FIG. 18 to FIG. 20, the second housing is a split-type structure, which includes a first cover 133 and a second cover 134. One end of the loudspeaker 120 extends into the first cover 133 along the vibration direction, and another end extends into the second cover 134 along the vibration direction. It may also be understood that the first cover 133 and the second cover 134, respectively, cover or shield two opposite ends of the loudspeaker 120 in the vibration direction. The sidewall of the first cover 133 disposed between the loudspeaker 120 and the inside wall 110a is the first transverse sidewall 1331. The sidewall of the second cover 134 disposed between the loudspeaker 120 and the outside wall 110b is the second transverse sidewall 1341. The sidewall of the first cover 133 that surrounds the vibration direction and is fixedly connected to the loudspeaker 120 is the first longitudinal sidewall 1332. The sidewall of the second cover 134 that surrounds the vibration direction and is fixedly connected to the loudspeaker 120 is the second longitudinal sidewall 1342.

The first longitudinal sidewall 1332 and the second longitudinal sidewall 1342 are spaced apart along the vibration direction to form an accommodating gap 130-4 surrounding the loudspeaker between the first cover and the second cover. The second microphone assembly may be at least partially embedded in the accommodating gap 130-4, thereby allowing full utilization of the structural space, improving the structural compactness of the sound generating assembly, and facilitating miniaturization of the sound generating unit 100 or even the open-ear headphone. In addition, wires, cables, flexible printed circuits (hereinafter FPC), or the like may also be accommodated and fixed in the accommodating gap 130-4.

In some embodiments, the first cover 133 and the first sealing ring 131 may be configured as independent and integral structural components, and the second cover 134 and the second sealing ring 132 may be configured as independent and integral structural components, thereby facilitating the disassembly and assembly of the loudspeaker 120 and the limiting assembly 130, and reducing the difficulty of disassembly and assembly of the sound generating assembly.

In some embodiments, the limiting assembly 130 may also omit the second housing, and use the first sealing ring 131 and the second sealing ring 132 to directly establish a sealing connection relationship between the loudspeaker 120 and the first housing 110. For example, the first sealing ring 131 is clamped and fixed between the loudspeaker 120 and the inside wall 110a, and cooperates with the loudspeaker 120 and the inside wall 110a to form the first acoustic cavity 111-1. The second sealing ring 132 is clamped and fixed between the loudspeaker 120 and the outside wall 110b, and cooperates with the loudspeaker 120 and the outside wall 110b to form the second acoustic cavity 111-2. In this case, the first sealing ring 131 and the second sealing ring 132 may be of an annular structure, and the corresponding sound guiding holes may also be formed by providing openings on the first sealing ring 131 and the second sealing ring 132.

In other embodiments, the limiting assembly 130 may also omit the first sealing ring 131 and the second sealing ring 132. The first acoustic cavity 111-1 and the second acoustic cavity 111-2 may be formed by using an interference fit abutment relationship between the second housing (e.g., the first cover 133 and the second cover 134) and the first housing 110 (e.g., the inside wall 110a and the outside wall 110b).

In other embodiments, the limiting assembly 130 may also adopt other suitable structures, as long as it can stably fix the loudspeaker 120 inside the first housing 110, or can cause the loudspeaker 120 to divide the accommodating cavity into the first acoustic cavity 111-1 and the second acoustic cavity 111-2. The details thereof will not be described again herein.

The sound guiding holes of the limiting assembly 130 may include a first sound guiding hole 130-1 communicating spaces on two sides of the first transverse sidewall 1331, and a second sound guiding hole 130-2 communicating spaces on two sides of the second transverse sidewall 1341. The first sound guiding hole 130-1 communicates the first acoustic cavity 111-1. It may also be understood that the first acoustic cavity 111-1 includes a cavity space between the first transverse sidewall 1331 and the inside wall 110a, and a cavity space between the first transverse sidewall 1331 and the loudspeaker 120 (e.g., the first diaphragm 121-1). The two cavity spaces located on two sides of the first transverse sidewall 1331 communicate through the first sound guiding hole 130-1, thereby forming the complete first acoustic cavity 111-1. Similarly, the second sound guiding hole 130-2 communicates the second acoustic cavity 111-2.

Based on this, by using the second housing as a peripheral protection structural component for the loudspeaker 120, a relatively stable structural assembly space may be provided for the loudspeaker. This not only facilitates the construction of the sound generating assembly into an integral functional module, but also facilitates the miniaturization and lightweight arrangement of the sound generating assembly or even the sound generating unit 100. For example, the second housing may be made of a metal material, thereby allowing the thickness of the housing wall of the second housing to be thinner and its weight to be lighter, while ensuring the mechanical strength of the second housing. At the same time, it also facilitates the design of the internal acoustic structure of the sound generating unit 100, providing support for active noise cancellation or the like.

In some embodiments, on the reference plane perpendicular to the vibration direction, the projections of the sound guiding holes of the limiting assembly 130, the first sound outlet 112-1, the second sound outlet 112-2, the first diaphragm 121-1, and the second diaphragm 121-2 at least partially overlap, to ensure that the sound output of the loudspeaker 120 exits outside the first housing 110.

By way of example, in some embodiments, on the reference plane perpendicular to the vibration direction, the projection of the first sound outlet 112-1 may fall within the projection of the first sound guiding hole 130-1. In some embodiments, on the reference plane perpendicular to the vibration direction, the projection of the first sound outlet 112-1 and the projection of the first sound guiding hole 130-1 have a first overlapping region, and an area of the first overlapping region is not less than 80% of an area of the projection of the first sound outlet 112-1. Such a configuration may allow air pushed by the diaphragm in the first sound guiding hole 130-1 of the limiting assembly 130 to be smoothly pushed out from the first sound outlet 112-1, thereby ensuring the acoustic output of the loudspeaker 120, and providing support for shifting the peak resonant frequency of the first resonant peak of the sound output from the first sound outlet 112-1 towards lower frequencies as much as possible and for shifting the peak resonant frequency of the second resonant peak towards higher frequencies as much as possible.

In some embodiments, on the reference plane perpendicular to the vibration direction, the projection of the second sound outlet 112-2 may fall within the projection of the second sound guiding hole 130-2. In some embodiments, on the reference plane perpendicular to the vibration direction, the projection of the second sound outlet 112-2 and the projection of the second sound guiding hole 130-2 have a second overlapping region, and an area of the second overlapping region is not less than 80% of an area of the projection of the second sound outlet 112-2. Such a configuration may allow air pushed by the diaphragm in the second sound guiding hole 130-2 of the limiting assembly 130 to be smoothly pushed out from the second sound outlet 112-2, thereby ensuring the acoustic output of the loudspeaker 120.

In some embodiments, on the reference plane perpendicular to the vibration direction, the projection of the first sound guiding hole 130-1 may fall within the projection of the first diaphragm 121-1. In some embodiments, on the reference plane perpendicular to the vibration direction, the projection of the first diaphragm 121-1 and the projection of the first sound guiding hole 130-1 have a third overlapping region, and an area of the third overlapping region is not less than 80% of an area of the projection of the first sound guiding hole 130-1. Such a configuration, when the first diaphragm 121-1 vibrates, allows air pushed by the first diaphragm 121-1 to smoothly enter the first sound guiding hole 130-1 of the limiting assembly 130, thereby ensuring the acoustic output of the loudspeaker 120 with maximum efficiency.

In some embodiments, on the reference plane perpendicular to the vibration direction, the projection of the second sound guiding hole 130-2 may fall within the projection of the second diaphragm 121-2. In some embodiments, on the reference plane perpendicular to the vibration direction, the projection of the second diaphragm 121-2 and the projection of the second sound guiding hole 130-2 have a fourth overlapping region, and an area of the fourth overlapping region is not less than 80% of an area of the projection of the second sound guiding hole 130-2. Such a configuration, when the second diaphragm 121-2 vibrates, allows air pushed by the second diaphragm 121-2 to smoothly enter the second sound guiding hole 130-2 of the limiting assembly 130, thereby ensuring the acoustic output of the loudspeaker 120 with maximum efficiency.

In some embodiments, based on the first transverse sidewall 1331 and the first sound guiding hole 130-1, and the second transverse sidewall 1341 and the second sound guiding hole 130-2, support may be provided for adjusting the resonant frequency and the specific acoustic impedance of the corresponding acoustic cavity, and the sound pressure level of the sound output from the corresponding sound outlet, to enhance the active noise cancellation effect.

By way of example, the first sound guiding hole 130-1 is formed by the cooperation of an opening of the first sealing ring 131 and an opening of the first transverse sidewall 1331. On the reference plane perpendicular to the vibration direction, the projection of the opening of the first transverse sidewall 1331, the projection of the first sound outlet 112-1, and the projection of the opening of the first sealing ring 131 have a fifth overlapping region. The area proportion of the projection of the opening of the first transverse sidewall 1331 in the fifth overlapping region is greater than the area proportion of the projection of the first sound outlet 112-1. For example, on the reference plane, in the fifth overlapping region, the area proportion of the projection of the opening of the first transverse sidewall 1331 may be greater than 30% (e.g., greater than 80%), and the area proportion of the projection of the first sound outlet 112-1 may be between 20% and 30%. Thus, it may minimize the impact on the sound output due to the excessively small opening areas of the first sound guiding hole 130-1 and the second sound guiding hole 130-2.

In some embodiments, the second sound guiding hole 130-2 includes an opening of the second sealing ring 132 and an opening of the second transverse sidewall 1341. On the reference plane perpendicular to the vibration direction, the projection of the opening of the second transverse sidewall 1341, the projection of the second sound outlet 112-2, and the projection of the opening of the second sealing ring 132 have a sixth overlapping region. The area proportion of the projection of the opening of the second transverse sidewall 1341 in the sixth overlapping region is greater than the area proportion of the projection of the second sound outlet 112-2. For example, on the reference plane, in the sixth overlapping region, the area proportion of the projection of the opening of the second transverse sidewall 1341 may be greater than 30% (e.g., greater than 80%), and the area proportion of the projection of the second sound outlet 112-2 may be between 20% and 30%. Thus, it may minimize the impact on the sound output due to the excessively small opening areas of the first sound guiding hole 130-1 and the second sound guiding hole 130-2.

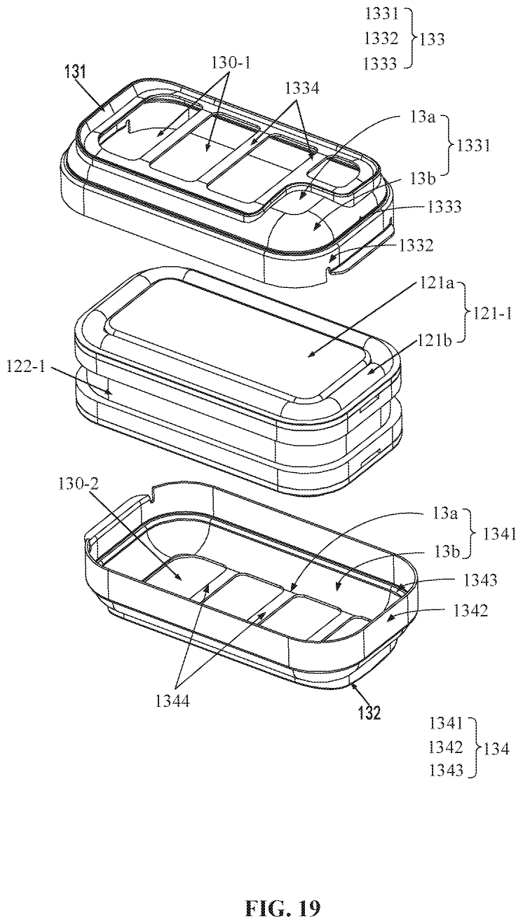

In some embodiments, referring to FIG. 18 and FIG. 19, the second housing has a rib structure, and the rib structure is disposed on the first transverse sidewall 1331 and the second transverse sidewall 1341. For convenience of distinction and description, the rib structure of the first transverse sidewall 1331 is defined as a first rib structure 1334, and the rib structure of the second transverse sidewall 1341 is defined as a second rib structure 1344. The first rib structure 1334 is located in the first sound guiding hole 130-1, and the second rib structure 1344 is located in the second sound guiding hole 130-2.

The first rib structure 1334 may be configured to support and fix a first acoustic resistance mesh 160-1 from the aforementioned embodiments inside the first acoustic cavity 111-1. For example, the first acoustic resistance mesh 160-1 may be adhesively fixed to the first rib structure 1334, covering the first sound guiding hole 130-1 and fixed to a side of the first transverse sidewall 1331 facing the inside wall 110a. The second rib structure 1344 may be configured to support and fix a second acoustic resistance mesh 160-2 from the aforementioned embodiments inside the second acoustic cavity 111-2. For example, the second acoustic resistance mesh 160-2 may be adhesively fixed to the second rib structure 1344, covering the second sound guiding hole 130-2 and fixed to a side of the second transverse sidewall 1341 facing the outside wall 110b.

On one hand, the rib structure may be utilized to adjust the opening area, shape, and distribution, or the like, of the corresponding sound guiding holes, to achieve adjustment of the acoustic characteristics or sound output of the corresponding acoustic cavity. For example, the rib structure may configure the corresponding sound guiding holes as a mesh hole structure. On the other hand, the acoustic resistance mesh may be fixed to the corresponding rib structure and the corresponding sidewall of the limiting assembly 130 by adhesive bonding, welding, or the like, thereby preventing the acoustic resistance mesh from vibrating due to air vibration when the loudspeaker 120 is working, further preventing adverse effects on the sound output (e.g., a frequency response curve or the like), and ensuring the active noise cancellation effect.

In some embodiments, the first transverse sidewall 1331 may be provided with a plurality of first rib structures 1334. The plurality of first rib structures 1334 may be spaced apart along the longitudinal direction of the sound generating unit 100. The quantity of the first rib structures 1334 may be between 2 and 5 (e.g., 2, 3, 4, or 5), to control the total area of the first rib structure 1334 within a reasonable range. In some embodiments, the dimension (i.e., the width of the single first rib structure 1334) of the single first rib structure 1334 along the longitudinal direction of the sound generating unit 100 may be between 0.5 mm and 1.5 mm. For example, the dimension of the single first rib structure 1334 along the longitudinal direction of the sound generating unit 100 may be 0.5 mm, 0.8 mm, 1.0 mm, 1.2 mm, or 1.5 mm, to control the total area of the first rib structure 1334 within a reasonable range.

Such a configuration, on one hand, allows the fixed area between the first acoustic resistance mesh 160-1 and the first transverse sidewall 1331 to be relatively large, thereby allowing the first acoustic resistance mesh 160-1 to be reliably fixed on the first transverse sidewall 1331, and preventing the first acoustic resistance mesh 160-1 from vibrating due to air vibration when the loudspeaker 120 is operating. On the other hand, it prevents the total area of the first rib structure 1334 from being excessively large, which may affect the opening area of the first sound guiding hole 130-1 and cause the opening area of the first sound guiding hole 130-1 to be excessively small.

In some embodiments, the second transverse sidewall 1341 may be provided with a plurality of second rib structures 1344. The plurality of second rib structures 1344 may be spaced apart along the longitudinal direction of the sound generating unit 100. The quantity of the second rib structures 1344 may also be between 2 and 5 (e.g., 2, 3, 4, or 5), to control the total area of the second rib structure 1344 within a reasonable range. In some embodiments, the dimension (i.e., the width of the single second rib structure 1344) of the single second rib structure 1344 along the longitudinal direction of the sound generating unit 100 may be between 0.5 mm and 1.5 mm. For example, the dimension of the single second rib structure 1344 along the longitudinal direction of the sound generating unit 100 may be 0.5 mm, 0.8 mm, 1.0 mm, 1.2 mm, or 1.5 mm, to control the total area of the second rib structure 1344 within a reasonable range.

Such a configuration, on one hand, allows the fixed area between the second acoustic resistance mesh 160-2 and the second transverse sidewall 1341 to be relatively large, thereby allowing the second acoustic resistance mesh 160-2 to be reliably fixed on the second transverse sidewall 1341, and preventing the second acoustic resistance mesh 160-2 from vibrating due to air vibration when the loudspeaker 120 is operating. On the other hand, it prevents the total area of the second rib structure 1344 from being excessively large, which may affect the opening area of the second sound guiding hole 130-2 and cause the opening area of the second sound guiding hole 130-2 to be excessively small.

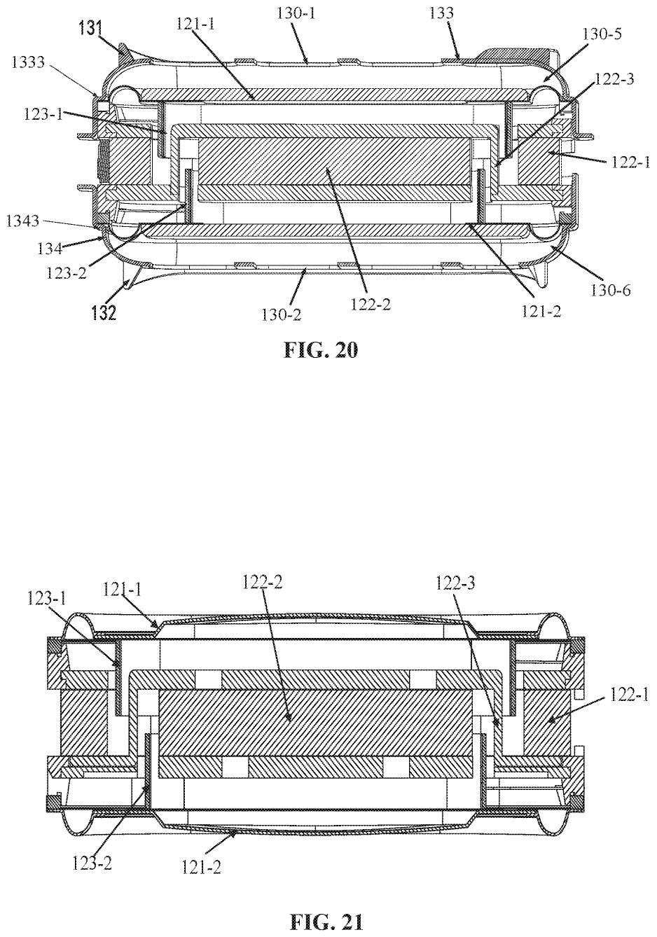

In some embodiments, referring to FIG. 20, in a case where the second housing has the first transverse sidewall 1331 and the second transverse sidewall 1341, the minimum distance between the first transverse sidewall 1331 and the center of the main region 121a of the first diaphragm 121-1 is greater than the maximum amplitude of the main region 121a vibrating towards the inside wall 110a, and the minimum distance between the second transverse sidewall 1341 and the center of the main region 121a of the second diaphragm 121-2 is greater than the maximum amplitude of the main region 121a vibrating towards the outside wall 110b.

Thus, based on the limitation of the distance between the amplitude of the diaphragm and the corresponding sidewall, it may prevent the diaphragm from colliding with the limiting assembly 130 during vibration, thereby ensuring the sound output effect.

In addition, in some embodiments where the second housing is omitted or the second housing does not have the first transverse sidewall 1331 or the second transverse sidewall 1341, to prevent the diaphragm from colliding with the corresponding housing sidewall in the first housing 110 during vibration, the minimum distance between the center of the main region 121a of the first diaphragm 121-1 and the inside wall 110a along the vibration direction is set to be greater than the maximum amplitude of the main region 121a vibrating towards the inside wall 110a, and the minimum distance between the center of the main region 121a of the second diaphragm 121-2 and the outside wall 110b along the vibration direction is set to be greater than the maximum amplitude of the main region 121a vibrating towards the outside wall 110b.

In some embodiments, referring to FIG. 19 and FIG. 20, the first transverse sidewall 1331 and the second transverse sidewall 1341 each have a central portion 13a and an arc portion 13b surrounding the central portion 13a, and an end of the arc portion 13b away from the central portion 13a is connected to the longitudinal sidewall of the second housing. In the vibration direction, the central portion 13a of the first transverse sidewall 1331 faces the main region 121a of the first diaphragm 121-1 (in this case, the first sound guiding hole 130-1 may be disposed in the central portion 13a of the first transverse sidewall 1331), and the arc portion 13b of the first transverse sidewall 1331 faces the surround region 121b of the first diaphragm 121-1. The central portion 13a of the second transverse sidewall 1341 faces the main region 121a of the second diaphragm 121-2 (in this case, the second sound guiding hole 130-2 may be disposed in the central portion 13a of the second transverse sidewall 1341), and the arc portion 13b of the second transverse sidewall 1341 faces the surround region 121b of the second diaphragm 121-2.

On one hand, a second avoidance space 130-5 may be formed between the surround region 121b of the first diaphragm 121-1 and the arc portion 13b of the first transverse sidewall 1331. When the first diaphragm 121-1 vibrates, the second avoidance space 130-5 is utilized to avoid the surround region 121b of the first diaphragm 121-1. At the same time, a second avoidance space 130-6 may also be formed between the surround region 121b of the second diaphragm 121-2 and the arc portion 13b of the second transverse sidewall 1341. When the second diaphragm 121-2 vibrates, the second avoidance space 130-6 is utilized to avoid the surround region 121b of the second diaphragm 121-2. In summary, by means of the avoidance space, collision of the surround region 121b of the diaphragm with the limiting assembly 130 during vibration may be prevented, to ensure the sound output effect.

On the other hand, compared to an approach of right-angle connection transition between the transverse sidewall and the longitudinal sidewall, based on the arc portion 13b forming an arc-shaped transition structure between the transverse sidewall and the longitudinal sidewall, the first housing may be configured into a compatible structural form with the second housing, thereby causing the corner region between the adjacent sidewalls of the first housing to tend to be curved and smooth, and avoiding prominent edges and corners. Thus, without affecting the vibration of the diaphragm, it can not only improve the wearing comfort of the sound generating unit 100 or the open-ear headphone, but also improve the appearance of the sound generating unit 100. At the same time, it also facilitates the adaptive design of the outer contour structure of the longitudinal sidewall and the loudspeaker 120. For example, by structurally adapting and fixing the longitudinal sidewall with a bracket in the loudspeaker 120, the loudspeaker 120 is stably positioned and fixed inside the second housing.

In some embodiments, a first annular platform 1333 is provided at a connection between the arc portion 13b of the first transverse sidewall 1331 and the first longitudinal sidewall 1332. A second annular platform 1343 is provided at a connection between the arc portion 13b of the second transverse sidewall 1341 and the second longitudinal sidewall 1342. The first annular platform 1333 and the second annular platform 1343 abut against two sides of the loudspeaker 120, respectively, along the vibration direction, and a sealing adhesive is provided in an abutting region.

Specifically, the first annular platform 1333 may form an abutment with the circumferential edge of the first diaphragm 121-1 to seal the first acoustic cavity 111-1 on the side of the first transverse sidewall 1331 facing the first diaphragm 121-1. For example, the first annular platform 1333 and/or the circumferential edge of the first diaphragm 121-1 may be pre-coated with the sealing adhesive. When the first cover 133 is assembled in place relative to the loudspeaker 120, sealing of the first acoustic cavity 111-1 is achieved on a side of the first transverse sidewall 1331 facing the first diaphragm 121-1. In this way, assembly can be achieved in a relatively simple manner.

The second annular platform 1343 may form an abutment with the circumferential edge of the second diaphragm 121-2, to achieve sealing of the second acoustic cavity 111-2 on a side of the second transverse sidewall 1341 facing the second diaphragm 121-2. For example, the second annular platform 1343 and/or the circumferential edge of the second diaphragm 121-2 may be pre-coated with the sealing adhesive. When the second cover 134 is assembled in place relative to the loudspeaker 120, sealing of the second acoustic cavity 111-2 is achieved on a side of the second transverse sidewall 1341 facing the second diaphragm 121-2. In this way, assembly can be achieved in a relatively simple manner.

In some of the aforementioned embodiments, the loudspeaker 120 may adopt dual diaphragms. Referring to FIG. 20, the loudspeaker 120 includes the first diaphragm 121-1, the second diaphragm 121-2, the magnetic circuit assembly, the voice coil assembly, or the like. The first diaphragm 121-1 and the second diaphragm 121-2 are spaced apart and opposite in the vibration direction, and the voice coil assembly and the magnetic circuit assembly are disposed between the first diaphragm 121-1 and the second diaphragm 121-2. At least a portion of the voice coil assembly extends into a magnetic gap of the magnetic circuit assembly, and at least one of the first diaphragm 121-1 and the second diaphragm 121-2 is connected to the voice coil assembly, to drive the voice coil assembly to move the first diaphragm 121-1 and the second diaphragm 121-2 to vibrate synchronously and in the same direction and generate a sound through the cooperation of the magnetic circuit assembly and the voice coil assembly.

Thus, the synchronous and same-direction vibration of the first diaphragm 121-1 and the second diaphragm 121-2 improves the consistency and stability of vibration of the loudspeaker 120, thereby facilitating a shift of a peak resonant frequency of a low-frequency resonant peak (e.g., a first resonant peak) of the sound output from the headphone towards a lower frequency, and a shift of a peak resonant frequency of a high-frequency resonant peak (e.g., a second resonant peak) towards a higher frequency, allowing the headphone to have a relatively flat output over a wider frequency range, and further enhancing the active noise cancellation effect.

In addition to structural features such as the sound outlets, the sound tuning hole, or the like, the structure and performance of the loudspeaker 120 itself also significantly influence the active noise cancellation achieved by the headphone. In some embodiments, the first diaphragm 121-1 and the second diaphragm 121-2 may be indirectly connected by the voice coil assembly to ensure the consistency of synchronous and same-direction vibration of the two diaphragms, thereby providing support for enhancing the active noise cancellation effect.

Hereinafter, the related structure of the dual-diaphragm loudspeaker 120 will be mainly described in a case where the first diaphragm 121-1 and the second diaphragm 121-2 are indirectly connected by the voice coil assembly.

In some embodiments, referring to FIGS. 20 and 21, the voice coil assembly includes a first voice coil 123-1 and a second voice coil 123-2, wherein the first voice coil 123-1 and the second voice coil 123-2 are arranged in the vibration direction; one end of the first voice coil 123-1 away from the second voice coil 123-2 is connected to the first diaphragm 121-1, and one end of the second voice coil 123-2 away from the first voice coil 123-1 is connected to the second diaphragm 121-2. The first voice coil 123-1 drives the first diaphragm 121-1 to vibrate, and the second voice coil 123-2 drives the second diaphragm 121-2 to vibrate, thereby causing the first diaphragm 121-1 and the second diaphragm 121-2 to vibrate synchronously and in the same direction.

By way of example, in some embodiments, the first voice coil 123-1 and the second voice coil 123-2 are connected at ends thereof closer to each other in the vibration direction. The voice coil assembly further includes a connection component (for ease of distinction and description, the connection component is defined as a first connection component 127), wherein the first connection component 127 is connected between the first voice coil 123-1 and the second voice coil 123-2. Further, the first voice coil 123-1 and the second voice coil 123-2 may be directly adhered using adhesive, or the like. In this case, the structural connection relationship between the first voice coil 123-1 and the second voice coil 123-2 is equivalent to constructing the integral voice coil assembly, thereby achieving an indirect connection between the first diaphragm 121-1 and the second diaphragm 121-2.

Firstly, by connecting the first diaphragm 121-1 and the second diaphragm 121-2 together using the integral voice coil assembly, the first voice coil 123-1 and the second voice coil 123-2 can share the magnetic circuit assembly. This arrangement, with the cooperation of the magnetic circuit assembly, can not only ensure the consistency of vibration of the first diaphragm 121-1 and the second diaphragm 121-2 (i.e., synchronous and same-direction vibration) but also enhance the driving force of the voice coil assembly, thereby being beneficial for the headphone to have a relatively flat output over a wider frequency range, and ensuring the active noise cancellation effect.

Secondly, when the first diaphragm 121-1 and the second diaphragm 121-2 vibrate synchronously and in the same direction, the volume of a common cavity 111-3 formed between the two does not change with the vibration of the diaphragms. The gas inside the common cavity 111-3 will not only not hinder the vibration of the first diaphragm 121-1 and the second diaphragm 121-2, but can instead act as an associated mass, moving back and forth with the vibration of the two diaphragms. This is beneficial for improving the consistency of vibration of the first diaphragm 121-1 and the second diaphragm 121-2, thereby enhancing the output performance of the headphone, and ensuring the active noise cancellation effect of the headphone.

Thirdly, the connection of the first voice coil 123-1 and the second voice coil 123-2 can not only ensure the consistency of vibration of the first diaphragm 121-1 and the second diaphragm 121-2 but also flexibly adjust a coil winding direction and an operating current direction of the voice coils, so that the voice coil assembly can utilize a magnetic field distribution of the magnetic circuit assembly.

Fourthly, in some scenarios where the waterproof requirements of the headphone are relatively high, for example, when the headphone is a headphone worn during swimming, the first housing 110 often needs to be completely sealed. In this case, if the first diaphragm 121-1 and the second diaphragm 121-2 vibrate in opposite directions, the air inside the common cavity 111-3 formed between the first diaphragm 121-1 and the second diaphragm 121-2 may be difficult to discharge. This may interfere with the vibration of the first diaphragm 121-1 and the second diaphragm 121-2, thereby affecting the output performance of the headphone. Therefore, driving the first diaphragm 121-1 and the second diaphragm 121-2 to vibrate synchronously and in the same direction using the first voice coil 123-1 and the second voice coil 123-2 can provide support for the completely sealed treatment of the first housing 110 or the loudspeaker.

In some embodiments, referring to FIGS. 20 and 21, the magnetic circuit assembly includes an outer magnetic circuit component 122-1, an inner magnetic circuit component 122-2, and a magnetic circuit connection component 122-3; wherein the outer magnetic circuit component 122-1 surrounds an outer periphery of the inner magnetic circuit component 122-2, and connects to the inner magnetic circuit component 122-2 via the magnetic circuit connection component 122-3, thereby enclosing and forming a magnetic gap of the magnetic circuit assembly between the outer magnetic circuit component 122-1 and the inner magnetic circuit component 122-2.

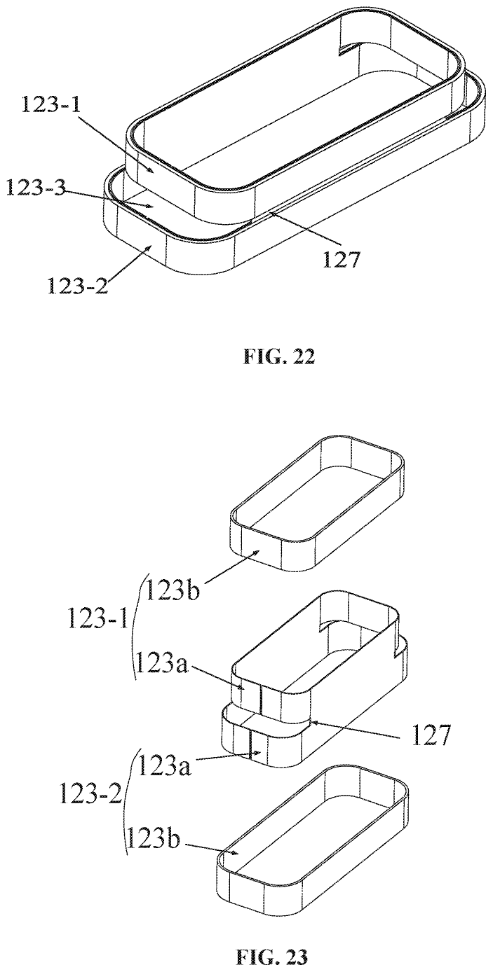

Correspondingly, referring to FIGS. 22 and 23, the first voice coil 123-1 and the second voice coil 123-2 may adopt an unequal diameter structure. For example, on the reference plane perpendicular to the vibration direction, a gap exists between a projection of the first voice coil 123-1 and a projection of the second voice coil 123-2 in the long axis direction or in the short axis direction, thereby causing the first voice coil 123-1 and the second voice coil 123-2 to have a connected portion and a separated portion. Thus, based on the existence of the gap between the two, a bypass channel 123-3 is formed between the first voice coil 123-1 and the second voice coil 123-2, allowing the magnetic circuit connection component 122-3 to pass through the voice coil assembly. It may also be understood that, based on the reference plane perpendicular to the vibration direction, the projection of the first voice coil 123-1 in the reference plane and the projection of the second voice coil 123-2 in the reference plane may partially connect or partially overlap, thereby forming the bypass channel 123-3 at a separated region of the first voice coil 123-1 and the second voice coil 123-2.

By way of example, referring to FIG. 22, the profile shape of the loudspeaker 120 is non-circular, for example, rectangular, elliptical, or the like. In this case, the sidewalls of the first voice coil 123-1 and the second voice coil 123-2 in the major axis direction may be defined as long side walls, and the sidewalls in the minor axis direction may be defined as short side walls. The projection of the long side wall of the first voice coil 123-1 on the reference plane and the projection of the long side wall of the second voice coil 123-2 on the reference plane are connected or at least partially overlap, whereas the projection of the short side wall of the first voice coil 123-1 on the reference plane and the projection of the short side wall of the second voice coil 123-2 on the reference plane are separated from each other. In this way, the bypass channel 123-3 can be formed between the short side wall of the first voice coil 123-1 and the short side wall of the second voice coil 123-2.

By way of example, the profile shape of the sound generating unit 100 or the loudspeaker 120 is substantially circular. In this case, the first voice coil 123-1 and the second voice coil 123-2 may be connected by the first connection component 127, to achieve partial connection and partial separation between the first voice coil 123-1 and the second voice coil 123-2 by means of a first connection component 127, in a case where a projection of the first voice coil 123-1 on the reference plane is a first annular ring, a projection of the second voice coil 123-2 on the reference plane is a second annular ring, and the first annular ring and the second annular ring have different diameters, thereby forming the bypass channel 123-3.

In this way, by setting the first voice coil 123-1 and the second voice coil 123-2 as an unequal diameter structure with locally unequal sizes, the bypass channel 123-3 formed between the first voice coil 123-1 and the second voice coil 123-2 can provide a bypass space for the magnetic circuit connection component 122-3. This is equivalent to placing the voice coil assembly within the same magnetic gap of the magnetic circuit assembly. This can not only enhance the structural stability of the magnetic circuit assembly itself, and provide support for a rapid combined assembly of the loudspeaker 120, but also be beneficial for reducing assembly difficulty and cost, and avoid the voice coil assembly from contacting the magnetic circuit assembly during movement, which affects the sound output. Meanwhile, the outer magnetic circuit component 122-1 adopting an annular structure surrounding an outer periphery of the inner magnetic circuit component 122-2 can cause the magnetic circuit assembly to have a larger design size, thereby, by increasing the volume of the magnet, the driving force of the voice coil assembly can be increased, improving the sound output performance of the loudspeaker 120.

In some embodiments, referring to FIG. 22, the overall profile shape of the loudspeaker 120 is configured to be rectangular, racetrack-shaped, or elliptical, or the like, adapted to the profile shape of the first housing 110 or the sound generating unit 100. In this case, the length of the long side wall of the first voice coil 123-1 in the long axis direction is greater than the width of the short side wall of the first voice coil 123-1 in the short axis direction, and the length of the long side wall of the second voice coil 123-2 in the long axis direction is greater than the width of the short side wall of the second voice coil 123-2 in the short axis direction. Meanwhile, the length of the long side wall of the first voice coil 123-1 in the long axis direction may be set to be less than the length of the long side wall of the second voice coil 123-2 in the long axis direction. In this case, the long side wall of the first voice coil 123-1 and the long side wall of the second voice coil 123-2 may be connected by the first connection component 127. In this way, the bypass channel 123-3 may be naturally formed between the short side walls of the two voice coils.

Correspondingly, the length of the magnetic circuit assembly in the long axis direction is greater than the width in the short axis direction, whereas a short side of the outer magnetic circuit component 122-1 and a short side of the inner magnetic circuit component 122-2 are connected via the magnetic circuit connection component 122-3, to configure the magnetic circuit assembly into a structural form with unconnected long sides and connected short sides. That is, the magnetic circuit connection component 122-3 passes through the magnetic gap between the short side of the inner magnetic circuit component 122-2 and the short side of the outer magnetic circuit component 122-1.

On one hand, on the premise of ensuring an integral structural form of the voice coil assembly, by connecting the long side walls of the two voice coils, it can not only enhance the structural stability of the voice coil assembly itself but also improve the consistency of vibration of the first diaphragm 121-1 and the second diaphragm 121-2, creating conditions for ensuring the active noise cancellation effect. On the other hand, the structural form of the magnetic circuit assembly with unconnected long sides and connected short sides is beneficial for forming a strong and uniform magnetic field between the long side of the inner magnetic circuit component 122-2 and the long side of the outer magnetic circuit component 122-1, allowing the magnetic field to pass through the magnetic gap as much as possible, achieving full utilization of the magnetic field, and effectively enhancing the driving force of the voice coil assembly.

In other embodiments, the first voice coil 123-1 and the second voice coil 123-2 may also adopt an equal diameter size. Specifically, on the reference plane perpendicular to the vibration direction, the projection of the first voice coil 123-1 and the projection of the second voice coil 123-2 overlap. In this case, on the reference plane parallel to the vibration direction, a gap exists between the projection of the first voice coil 123-1 and the projection of the second voice coil 123-2 in the vibration direction, thereby also forming the bypass channel 123-3 between the two based on the existence of the gap. In this case, after the magnetic circuit connection component 122-3 passes through the bypass channel 123-3 along a direction perpendicular to the vibration direction, the two ends of the magnetic circuit connection component 122-3 are respectively connected to the inner magnetic circuit component 122-2 and the outer magnetic circuit component 122-1.

As described above, the first voice coil 123-1 and the second voice coil 123-2 may be connected by the first connection component 127. In some embodiments, referring to FIG. 23, the first voice coil 123-1 and the second voice coil 123-2 each include a voice coil former 123a and a coil 123b wound around an outer periphery of the voice coil former. For ease of distinction and description, the voice coil former 123a and the coil 123b of the first voice coil 123-1 are respectively defined as a first former and a first coil, and a voice coil former and a coil of the second voice coil 123-2 are respectively defined as a second former and a second coil. The first former and the second former are respectively disposed between the inner magnetic circuit component 122-2 and the outer magnetic circuit component 122-1 by surrounding the inner magnetic circuit component 122-2, whereas the first connection component 127 is connected between the first former and the second former, thereby not only achieving separation of the coils of the two voice coils but also forming the bypass channel 123-3 between the two voice coil formers.

Based on the connection relationship between the first former, the second former, and the first connection component 127, the former structure of the voice coil is formed. Due to the relatively high structural strength and strong connection stability of the former structure, it can further ensure the consistency of vibration between the first diaphragm 121-1 and the second diaphragm 121-2, and is applicable to the first voice coil 123-1 and the second voice coil 123-2 of different sizes.

In some embodiments, the voice coil assembly may adopt an integral former structure. Specifically, referring to FIG. 23, the first connection component 127, the first former, and the second former are an integral structure, which can effectively avoid the coil from detaching from the former during vibration of the voice coil assembly, thereby enhancing the structural stability and integrity of the voice coil assembly itself.

In some embodiments, the voice coil assembly may adopt a split former structure. Specifically, the first former has an extended portion extending beyond the first coil (e.g., the extended portion of the first former is located at a long side of the first voice coil 123-1), and the second former has an extended portion extending beyond the second coil (e.g., the extended portion of the second former is located at a long side of the second voice coil 123-2). The extended portion of the first former and the extended portion of the second former are fixedly connected (e.g., adhered). This can not only achieve the connection of the first voice coil 123-1 and the second voice coil 123-2 and form the former structure, but also be adapted to a size difference between the first voice coil 123-1 and the second voice coil 123-2 to form the bypass channel 123-3. In this case, it may be understood that this is equivalent to constructing the voice coil assembly with the former structure by omitting the first connection component 127. It may also be understood that an extended portion of the first voice coil 123-1 and an extended portion of the second voice coil 123-2 are connected to form the first connection component 127.

In other embodiments, the first former and the second former may also not have an extended portion. In this case, the first connection component 127 may adopt a patch structure, wherein the first connection component 127 is adhered and fixed on the same side of the first former and the second former, thereby also constructing the voice coil assembly with the former structure.

The foregoing is merely an embodiment of the present disclosure, and is not intended to limit the patent scope of the present disclosure. Any equivalent structure or equivalent process transformation made by utilizing the contents of the present disclosure and drawings, or directly or indirectly applied to other related technical fields, is likewise included within the patent protection scope of the present disclosure.

1. An open-ear headphone, comprising: a sound generating unit and an ear hook, wherein the ear hook is configured to place the sound generating unit near an ear without blocking an ear canal in a wearing state; the sound generating unit includes a first housing and a sound generating assembly, the sound generating assembly is disposed inside the first housing; the first housing has an inside wall and an outside wall disposed opposite to each other, the inside wall faces the ear canal in the wearing state, and the outside wall is farther from the ear canal than the inside wall in the wearing state; the sound generating assembly includes a loudspeaker, the loudspeaker includes a first diaphragm and a second diaphragm, the first diaphragm and the second diaphragm are disposed opposite to each other in a vibration direction and vibrate synchronously and in the same direction, the first diaphragm is closer to the inside wall than the second diaphragm, the first diaphragm and the inside wall are spaced apart and opposite to each other in the vibration direction to form a first acoustic cavity, the second diaphragm and the outside wall are spaced apart and opposite to each other in the vibration direction to form a second acoustic cavity; the inside wall is provided therethrough with a first sound outlet, the first sound outlet is acoustically connected to the loudspeaker through the first acoustic cavity; the outside wall is provided therethrough with a second sound outlet, the second sound outlet is acoustically connected to the loudspeaker through the second acoustic cavity; the first sound outlet includes a plurality of first micro-holes arranged in an array; the second sound outlet includes a plurality of second micro-holes arranged in an array; and the open-ear headphone further comprises a microphone assembly, wherein the open-ear headphone is configured to adjust an output of the loudspeaker based on ambient noise collected by the microphone assembly to achieve active noise cancellation of the ambient noise.

2. The open-ear headphone of claim 1, wherein each of the first diaphragm and the second diaphragm includes a main region and a surround region surrounding the main region; the surround region of the first diaphragm and the surround region of the second diaphragm arch away from each other; the main region of the first diaphragm and the main region of the second diaphragm have a first interval distance along the vibration direction; an inner wall surface of the inside wall and an inner wall surface of the outside wall have a second interval distance that is a farthest distance along the vibration direction; a ratio of the first interval distance to the second interval distance is more than or equal to 70%; and the loudspeaker further includes a magnetic circuit assembly disposed between the first diaphragm and the second diaphragm.

3. The open-ear headphone of claim 1, wherein a total opening area of the plurality of second micro-holes is greater than a total opening area of the plurality of first micro-holes.

4. The open-ear headphone of claim 3, wherein a quantity of the plurality of second micro-holes is greater than a quantity of the plurality of first micro-holes.

5. The open-ear headphone of claim 1, further comprising a first acoustic resistance mesh and a second acoustic resistance mesh, wherein the first acoustic resistance mesh is disposed at the first sound outlet and inside the first acoustic cavity; the second acoustic resistance mesh is disposed at the second sound outlet and inside the second acoustic cavity; and a specific acoustic impedance of the first acoustic resistance mesh is less than a specific acoustic impedance of the second acoustic resistance mesh.

6. The open-ear headphone of claim 4, wherein at least a portion of a structure of the first housing extends into a concha cavity; the ear hook includes an adapter section connected to the sound generating unit; the microphone assembly includes a first microphone assembly; the first microphone assembly is disposed inside the adapter section; the adapter section is provided with a first sound pickup hole on a side close to the outside wall; and the first microphone assembly collects the ambient noise through the first sound pickup hole.

7. The open-ear headphone of claim 4, wherein at least a portion of a structure of the first housing extends into a concha cavity; the first housing further includes an upside wall, the upside wall faces a top of a head in the wearing state and connects the inside wall and the outside wall; the microphone assembly includes a second microphone assembly; the upside wall is provided with an opening; a portion of the second microphone assembly is accommodated inside the first housing via the opening, and another portion of the second microphone assembly protrudes outside the first housing; the open-ear headphone further comprises a protrusion disposed on the upside wall, wherein the portion of the second microphone assembly protruding outside the first housing is covered by the protrusion; the protrusion is provided with a second sound pickup hole on a side close to the outside wall; and the second microphone assembly collects the ambient noise through the second sound pickup hole.

8. The open-ear headphone of claim 1, further comprising a limiting assembly, wherein the limiting assembly sealingly fixes the loudspeaker inside the first housing and sealingly forms the first acoustic cavity and the second acoustic cavity; the limiting assembly includes a first sealing ring and a second sealing ring; the first sealing ring elastically abuts against the inside wall; the second sealing ring elastically abuts against the outside wall; and the first sealing ring and the second sealing ring sealingly fix the loudspeaker from two sides in the vibration direction.

9. The open-ear headphone of claim 8, wherein the limiting assembly further includes a first cover and a second cover; the first cover includes a first transverse sidewall and a first longitudinal sidewall, the first transverse sidewall is disposed between the loudspeaker and the inside wall, and the first longitudinal sidewall surrounds and is fixedly connected to the loudspeaker around the vibration direction; the second cover includes a second transverse sidewall and a second longitudinal sidewall, the second transverse sidewall is disposed between the loudspeaker and the outside wall, and the second longitudinal sidewall surrounds and is fixedly connected to the loudspeaker around the vibration direction; one end of the first sealing ring in the vibration direction is fixed to the first transverse sidewall, and another end of the first sealing ring abuts against the inside wall; and one end of the second sealing ring in the vibration direction is fixed to the second transverse sidewall, and another end of the second sealing ring abuts against the outside wall.

10. The open-ear headphone of claim 9, wherein the first longitudinal sidewall and the second longitudinal sidewall are spaced apart along the vibration direction to form an accommodating gap surrounding the loudspeaker between the first cover and the second cover; the microphone assembly includes a second microphone assembly; at least a portion of the second microphone assembly is embedded in the accommodating gap; and the second microphone assembly is configured to collect the ambient noise.

11. The open-ear headphone of claim 9, further comprising a first acoustic resistance mesh and a second acoustic resistance mesh, wherein the first transverse sidewall is provided with a first rib structure; the second transverse sidewall is provided with a second rib structure; the first rib structure is configured to support and fix the first acoustic resistance mesh inside the first acoustic cavity; the second rib structure is configured to support and fix the second acoustic resistance mesh inside the second acoustic cavity; and a quantity of the first rib structure and a quantity of the second rib structure are each between 3 and 5.

12. The open-ear headphone of claim 9, wherein each of the first diaphragm and the second diaphragm includes a main region and a surround region surrounding the main region; the surround region of the first diaphragm and the surround region of the second diaphragm arch away from each other; each of the first transverse sidewall and the second transverse sidewall has a central portion and an arc portion surrounding the central portion; in the vibration direction, the central portion of the first transverse sidewall faces the main region of the first diaphragm, and the arc portion of the first transverse sidewall faces the surround region of the first diaphragm; and the central portion of the second transverse sidewall faces the main region of the second diaphragm, and the arc portion of the second transverse sidewall faces the surround region of the second diaphragm.

13. The open-ear headphone of claim 12, wherein a first annular platform is provided at a connection between the arc portion of the first transverse sidewall and the first longitudinal sidewall; a second annular platform is provided at a connection between the arc portion of the second transverse sidewall and the second longitudinal sidewall; the first annular platform and the second annular platform abut against two sides of the loudspeaker, respectively, along the vibration direction; and a sealing adhesive is provided in an abutting region.

14. The open-ear headphone of claim 9, wherein the limiting assembly is provided with a first sound guiding hole communicating spaces on two sides of the first transverse sidewall and a second sound guiding hole communicating spaces on two sides of the second transverse sidewall; on a reference plane perpendicular to the vibration direction, a projection of the first sound guiding hole and a projection of the first diaphragm have a first overlapping region, an area ratio of the first overlapping region to the projection of the first sound guiding hole is more than or equal to 80%, a projection of the first sound outlet and the projection of the first sound guiding hole have a second overlapping region, an area ratio of the second overlapping region to the projection of the first sound outlet is more than or equal to 80%, a projection of the second sound guiding hole and a projection of the second diaphragm have a third overlapping region, an area ratio of the third overlapping region to the projection of the second sound guiding hole is more than or equal to 80%, and a projection of the second sound outlet and the projection of the second sound guiding hole have a fourth overlapping region, an area ratio of the fourth overlapping region to the projection of the second sound outlet is more than or equal to 80%.

15. The open-ear headphone of claim 1, wherein the loudspeaker further includes a magnetic circuit assembly and a voice coil assembly; the magnetic circuit assembly is disposed between the first diaphragm and the second diaphragm; the voice coil assembly includes a first voice coil and a second voice coil connected to each other and arranged in the vibration direction of the first diaphragm and the second diaphragm; the first voice coil and the second voice coil are respectively disposed through a magnetic gap of the magnetic circuit assembly; one end of the first voice coil away from the second voice coil is connected to the first diaphragm, and one end of the second voice coil away from the first voice coil is connected to the second diaphragm; and the magnetic circuit assembly cooperates with the voice coil assembly to drive the first diaphragm and the second diaphragm to vibrate synchronously and in the same direction.

16. The open-ear headphone of claim 1, wherein the first housing is an integral metal component; a thickness of the inside wall and a thickness of the outside wall are between 0.2 mm and 1 mm; an aperture diameter of each of the plurality of first micro-holes is more than or equal to 0.2 mm; an interval distance between adjacent first micro-holes is between 0.2 mm and 4 mm; an aperture diameter of each of the plurality of second micro-holes is more than or equal to 0.2 mm; and an interval distance between adjacent second micro-holes is between 0.2 mm and 4 mm.

17. The open-ear headphone of claim 1, wherein the ear hook includes an adapter section connected to the sound generating unit; the first housing is an integral metal component; the first housing is provided with a first opening at an end close to the adapter section; the sound generating assembly is inserted into the first housing through the first opening; and the adapter section is configured to be in a plug-in fit with the first housing via the first opening.

18. The open-ear headphone of claim 17, wherein the first housing further includes an upside wall and an end wall; the upside wall is disposed facing a top of a head in the wearing state and connects the inside wall and the outside wall; the end wall is located at an end of the first housing away from the adapter section and connects the inside wall, the outside wall, and the upside wall; wherein the open-ear headphone further comprises a protrusion disposed on at least one of the upside wall or the end wall; at least one of the upside wall or the end wall is provided with a second opening; a portion of the protrusion is embedded in the second opening, and another portion of the protrusion protrudes outside the first housing; a hardness of the protrusion is less than a hardness of the first housing; at least a portion of a structure of the first housing extends into a concha cavity; and the protrusion contacts a concha cavity wall.

19. The open-ear headphone of claim 1, wherein at least a portion of a structure of the first housing extends into a concha cavity; the first housing further includes an end wall, the end wall is located at an end of the first housing away from the ear hook and connects the inside wall and the outside wall; and the first sound outlet is disposed close to the end wall.

20. The open-ear headphone of claim 19, wherein the inside wall is provided therethrough with a sound tuning hole; the sound tuning hole is disposed at a position farther from the end wall than the first sound outlet; and an interval distance between the sound tuning hole and a nearest first micro-hole is more than or equal to 5 times an interval distance between adjacent first micro-holes.
